(19) United States
(12) Patent Application Publication
(10) Pub. No.: US 2011/0087618 A1
(43) Pub. Date: Apr. 14, 2011

(54) RULE 10b5-1 TRADING PLAN SYSTEM AND METHOD

(76) Inventors: BARRY EDWARD PAPINA, Union, KY (US); JAMES ANDREW NEAL, Franklin, TN (US)

(21) Appl. No.: 12/902,086

(22) Filed: Oct. 11, 2010

Related U.S. Application Data
(60) Provisional application No. 61/250,146, filed on Oct. 9, 2009.
(60) Provisional application No. 61/391,165, filed on Oct. 8, 2010.

(51) Int. Cl. G06Q 40/00

(52) U.S. Cl. 705/36 R

(57) ABSTRACT

A system for creating, administering, executing and reporting of Rule 10b5-1 trading plans, and similar trading plans. The system comprises one or more computer programs or modules operating on a server connected to a network, accessed through a web browser or portal program operating on a computing device connected to the network. Users include, but are not limited to, brokers, issuers of securities, and executives or insiders engaging in transactions, or their accountants, financial planners, or other representatives. One or more users can create, finalize, and approve a trading plan. The system allows issuers and executives or insiders access to trading plan data and allows them to operative proactively. Plans may be created, reviewed and approved with the system, as opposed to physically reviewing numerous hard copies. The system may be equipped with a plurality of different investment and liquidation strategies, allowing for a more efficient plan creation process.

This application claims benefit of and priority to U.S. Provisional Application No. 61/250,146, filed Oct. 9, 2009, by Barry Edward Papina, et al., and U.S. Provisional Application No. 61/391,165, filed Oct. 8, 2010, by Barry Edward Papina, et al., and is entitled to those filing dates for priority. The specification, figures, appendix, and complete disclosure of U.S. Provisional Application No. 61/250,146 and 61/391,165 are incorporated herein by specific reference for all purposes.

### FIELD OF INVENTION

This invention relates to a system and related method for a web-based system for facilitating the creation, administration, execution and reporting of securities trading plans.

### BACKGROUND OF THE INVENTION

Insider trading restrictions are a constant concern for many companies and their executives, as executives and similar persons often receive significant compensation in the form of options, restricted stock, and/or stock grants, and thus have a continuing need to sell stock or similar securities. Rule 10b5, a rule enacted by the U.S. Securities and Exchange Commission (SEC), prohibits insider trading in securities. In order to resolve an issue over the definition of insider trader, the SEC enacted Rule 10b5-1 in 2000.

Paragraph (c) of Rule 10b5-1 creates an affirmative defense to any charge of insider trading, designed to cover situations in which a person can demonstrate that the material nonpublic information was not a factor in the trading decision. This provision provides for an affirmative defense when the trade was made pursuant to a contract, instructions given to another, or a written plan that did not permit the person to exercise any subsequent influence over how, when, or whether to effect purchases or sales, and where the plan or contract or instructions were created before the insider had inside information. Thus, as long as a plan is adopted at a time when the insider has no inside information, he or she is protected from insider trading liability even if he or she comes into possession of material, non-public information at the time the sales occur.

Rule 10b5-1 trading plans have proven of use in allowing executives and others who would be considered insiders to sell stock and securities without consideration for insider trading restrictions. A trading plan must be in writing, and must state the number or percentage of shares to be bought or sold, the prices at which shares will be bought or sold, and the timing of sales or purchases. Many brokers have simple, one-page plan forms for use to put a plan into place. Some brokers also put a “wall of separation” between the insider and the persons responsible for executing the plan, in order to prevent the insider from attempting to influence how or when transactions are made under the plan.

### SUMMARY OF INVENTION

In various embodiments, the present invention comprises a system for creating, administering, executing and reporting of Rule 10b5-1 trading plans, and similar trading plans. In one embodiment, the system comprises one or more computer programs or modules operating on a server connected to a network, including but not limited to the Internet. Users can access the system, or components of the system, through a web browser or portal program operating on a computing device connected to the network. Access is secure, and may be password protected and/or encrypted. Different classifications of users are entitled to different levels of access to the system. Users include, but are not limited to, brokers, issuers of securities, and executives or insiders engaging in transactions, or their accountants, financial planners, or other representatives.

In one embodiment, the system comprises a program whereby one or more users can create, finalize, and approve a trading plan. The system allows issuers and executives or insiders access to trading plan data and allows them to operative proactively. Plans may be created, reviewed and approved with the system, as opposed to physically reviewing numerous hard copies. The system may be equipped with a plurality of different investment and liquidation strategies, allowing for a more efficient plan creation process.

A user responsible for carrying out the trading plan, such as a broker, then monitors and executes the plan. The system can trigger alerts and customizable workflows based upon the plan's specific orders. The issuer (and others) may monitor trading plan executions and future orders in real time. The system provides issuers with an extensive “radar screen” to process and monitor their executives' plans. A reporting module further provides a full suite of query-based and customizable reports allowing desired data to be captured and reported.

### DESCRIPTION OF THE DRAWINGS

FIG. 1 shows a view of a system in accordance with an embodiment of the present invention.

FIGS. 2-57 are screenshots of a web page in accordance with an exemplary embodiment of the present invention.

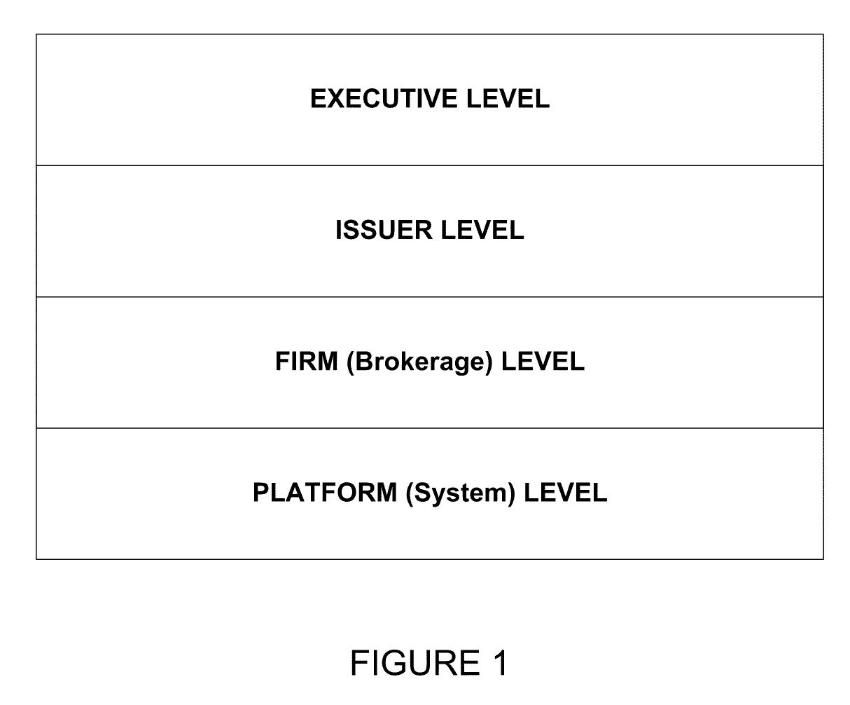

### DETAILED DESCRIPTION OF EXEMPLARY EMBODIMENTS

In one exemplary embodiment, the present system comprises a system for creating, administering, executing and reporting of Rule 10b5-1 trading plans, and similar trading plans. In one embodiment, the system comprises one or more computer programs or modules operating on a server connected to a network, including but not limited to the Internet. Users can access the system, or components of the system, through a web browser or portal program operating on a computing device connected to the network. Access is secure, and may be password protected and/or encrypted. Different classifications of users are entitled to different levels of access to the system. Users include, but are not limited to, brokers, issuers of securities, and executives or insiders engaging in transactions, or their accountants, financial planners, or other representatives.

In one embodiment, the system comprises a program whereby one or more users can create, finalize, and approve a trading plan. The system allows issuers and executives or insiders access to trading plan data and allows them to operative proactively. Plans may be created, reviewed and approved with the system, as opposed to physically reviewing numerous hard copies. The system may be equipped with a plurality of different investment and liquidation strategies, allowing for a more efficient plan creation process. A user responsible for carrying out the trading plan, such as a broker, then monitors and executes the plan. The system can trigger alerts and customizable workflows based upon the plan's specific orders. The issuer (and others) may monitor trading plan executions and future orders in real time. The system provides issuers with an extensive “radar screen” to process and monitor their executives' plans. A reporting module further provides a full suite of query-based and customizable reports allowing desired data to be captured and reported.

In one exemplary embodiment, the system is managed by a firm or entity through the “Platform” component or level. This is the highest level of access in the system, and access is limited to the firm's management or select users. It provides visibility to all levels of data from the different user groups as well as controlling the permissions-based access of the user groups.

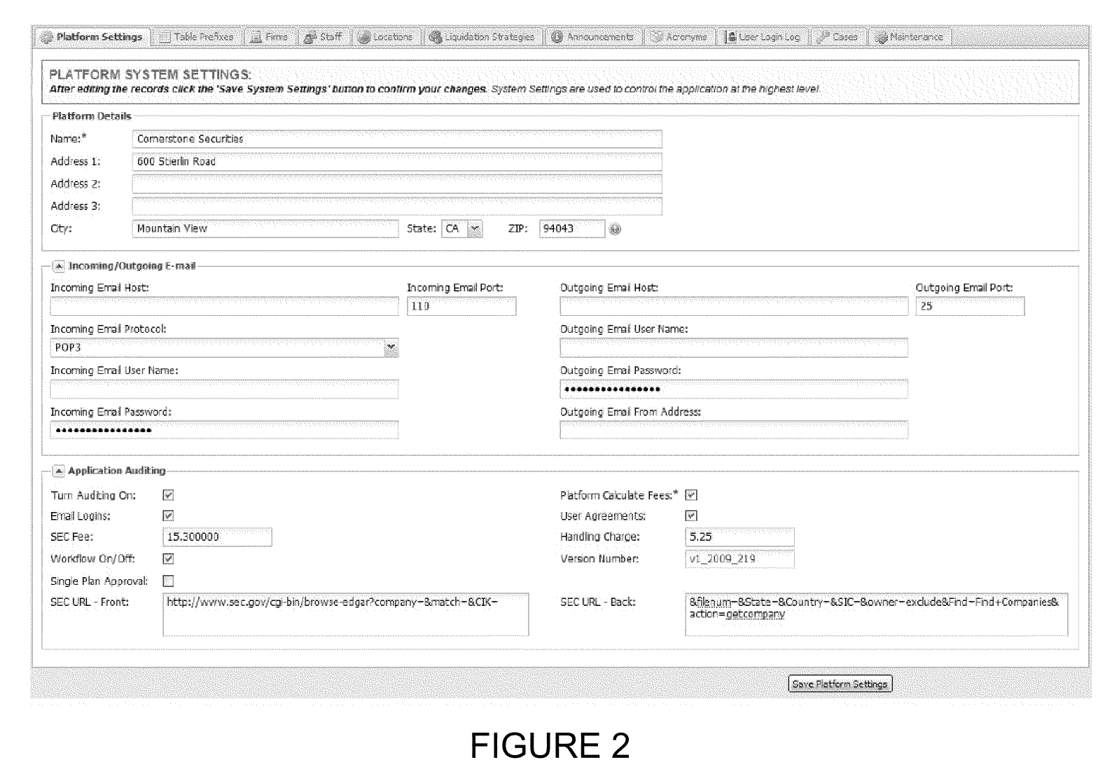

FIG. 2 shows an exemplary embodiment of a user interface. The user, after logging in, can access several areas by clicking on a tab, button or icon on the interface. The Platform System Settings area, as seen in FIG. 2, provides for the capture and modification of demographic information, settings for incoming and outgoing email from the platform, and auditing preferences. Access is limited to users with platform/system level authority. In one exemplary embodiment, this information includes, but is not limited to, the following: name, address, city, state, zip code, incoming email host, incoming email protocol, incoming email user name, incoming email password, incoming email port; outgoing email host, outgoing email user name, outgoing email password, outgoing email port, and outgoing email from address. Auditing fields include, but are not limited to, the following: turning auditing on/off switch, email logins flag, SEC fee, workflow on/off switch, platform calculate fees flag, user agreements flag, handling charge, platform version number, and SEC URL (which may be in parts). An Edit button or icon may appear on this and other screens to allow the screen or interface to go into edit mode for modifications or changes by the user. In some case, a Delete button or icon may be used to allow the user to delete an entry or certain information.

The Table Prefixes area provides for the manipulation of the standard table specific prefixes. If a firm requires a different prefix for system assigned unique IDs, these setting may be managed by this function. For example, the standard issuer number may be ISS0001, where ISS is the default prefix. The prefix can be changed to suit the particular issuer or firm (subject to any limitations in that particular embodiment, such as 3 characters as shown in the figure). In one exemplary embodiment, this information includes, but is not limited to, the following: ID prefix account, firm, issuer, staff and case.

The Firms section provides for adding new firms to the system or managing existing firms. This allows the system great latitude in the event of an acquisition or similar event. In one exemplary embodiment, this information includes, but is not limited to, the following: firm name, current firm status, unique firm number, user that created the firm entry, the entry date of the firm, the user that last modified the firm entry, and the date the firm was last modified.

The Staff section provides for adding new or managing existing staff in the system. This section includes all end users of the system: e.g., administration group, brokers, traders, operations, and the like. In one exemplary embodiment, this information includes, but is not limited to, the following: staff member name, job title, system level login name, unique system assigned number, reporting relationships, the role or access level, and staff member status.

The Locations section provides the ability to track different locations applicable to the level of the system. In one exemplary embodiment, this information includes, but is not limited to, the following: name of the location, platform-specific location code (which may be user defined), and current location status.

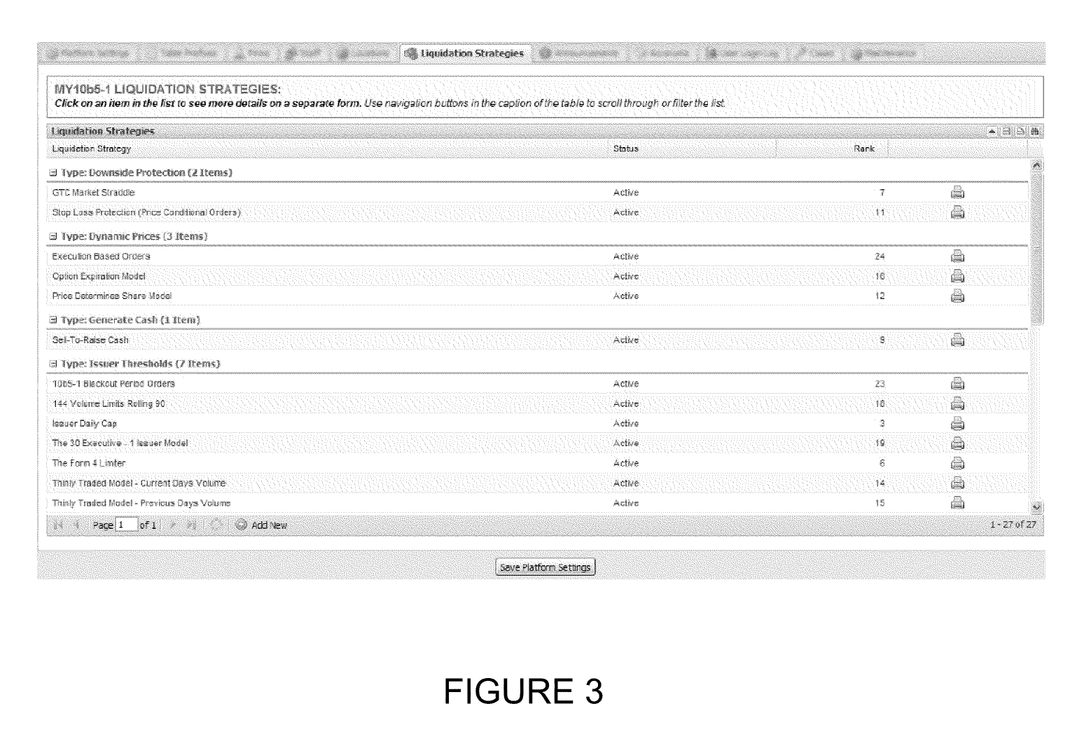

The Liquidation Strategies section, as seen in FIG. 3, provides for adding new or managing existing liquidation strategies. Each liquidation strategy is specifically designed to meet different liquidation needs, and the system is programmed to manage each of these. FIG. 3 shows a grid sorted by liquidation strategy types. In one exemplary embodiment, this information includes, but is not limited to, the following: liquidation strategy, liquidation strategy type (e.g., RSA/RSU lapse, upside potential, etc.), current liquidation strategy status, and the firm/platform level ranking for the strategy.

The Announcements section provides for adding or managing existing announcements. Announcements include, but are not limited to, the following: system downtime notification; operational details; and other necessary communications for system users. Announcements may be customized for visibility to a selected set of users. Access to creating announcements and user visibility selections are controlled at this level. In one exemplary embodiment, this information includes, but is not limited to, the following: announcement title, expiration date, system owner of the announcement entity.

The Acronyms section provides for the addition and deletion of system/platform or industry specific acronyms. This section may be particularly useful for new employees or users that may need assistance with system/platform specific terms. When the acronym row is expanded, the full description of the acronyms can be viewed. In one exemplary embodiment, this information includes, but is not limited to, the following: acronym, type, department the acronym is applicable to, entry date, and system user that created the acronym.

The User Login Log section provides for viewing all user login and logout activity for the system. In one exemplary embodiment, this information includes, but is not limited to, the following: name of user, access level of user, type of log activity, IP address the user accesses the system through, time and date of the log activity, and a detailed view of the user login log entry.

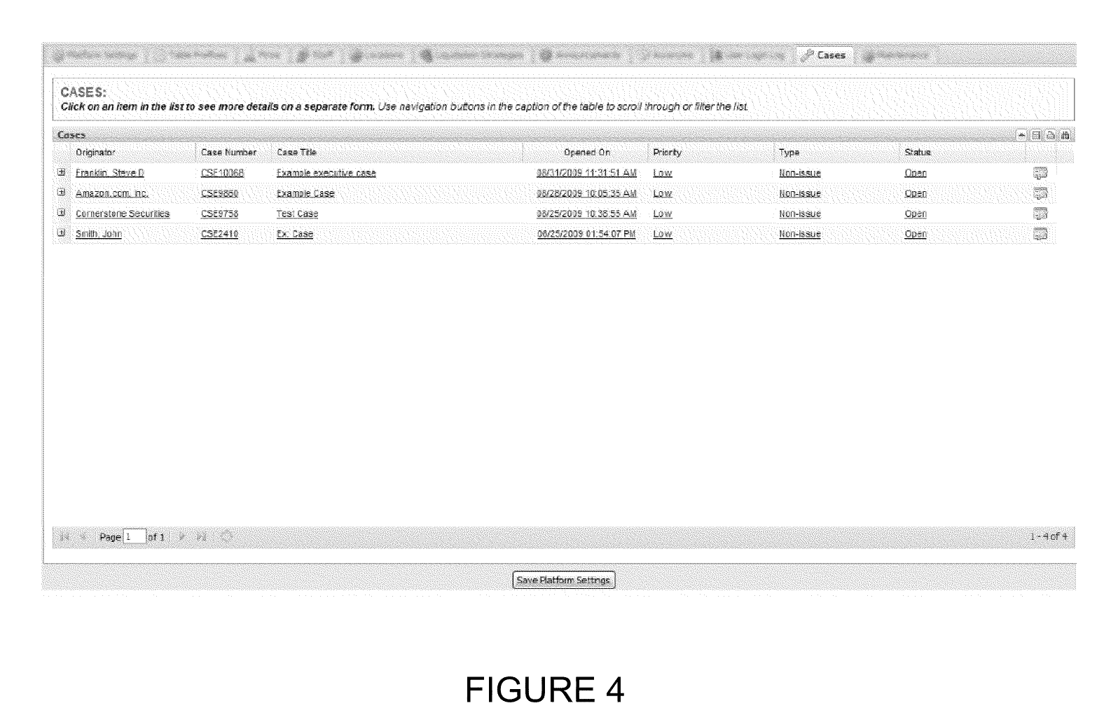

The Cases section, as seen in FIG. 4, provides for the creation, viewing, or editing of cases at all levels of the system. Cases fill the role of CRM service requests for the system. For example, if an issue needs to be assigned to a particular individual or group for review or action, this action can be accomplished through the case section. This enables all entitled or authorized users to obtain the status and progress of any outstanding issues. In one exemplary embodiment, this information includes, but is not limited to, the following: user originating the case, case number, case title, date case first entered into system, case priority level (e.g., low, high, critical, etc.), case type (e.g., non-issue, problem, etc.), and current case status.

The Maintenance section provides a review of modifications that have been made in the system. In one exemplary embodiment, this information includes, but is not limited to, the following: job name, date and time of job completion, and a detailed view of the maintenance job.

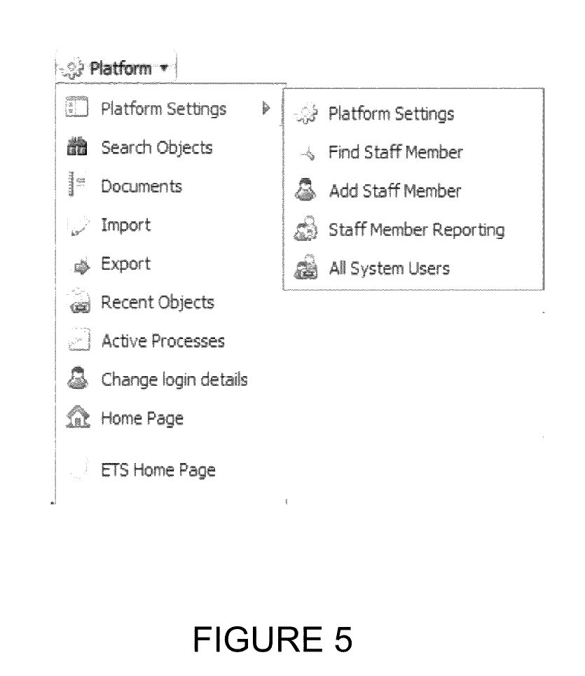

Platform Processes, as seen in FIG. 5, provide mechanisms to navigate to platform level settings, query the data, add staff members, and accomplish similar actions. In one exemplary embodiment, these options include, but are not limited to, the following: platform settings, find staff member, add staff member, staff member reporting, all system users, search object, documents, import objects, export objects, recent objects, active processes, change login details, home page, and firm home page.

The Platform Settings process launches the Platform Information section of the application. The Home Page selection returns the user to the default page or visual perspective. The Firm Home Page selection returns the user to a firm's homepage.

The Find Staff Member process launches a query displaying all system users of type “staff member”, which may be sorted by status or other parameter. In one exemplary embodiment, this information includes, but is not limited to, the following: full name, number, job title, role, email address, platform staff member the selected staff members reports to, and the role of the reports-to platform staff member.

The Add Staff Member process launches the new staff member entry screen. In one exemplary embodiment, this information includes, but is not limited to, the following: last name, first name, email address, current status, access level, login name, password, platform staff member the selected staff members reports to, and the role and job title of the reports-to platform staff member.

The Staff Member Reporting process launches a query displaying the reporting relationships between system staff members, which may be sorted by “Reports To” or other parameters. In one exemplary embodiment, this information includes, but is not limited to, the following: full name, role, platform staff member the selected staff members reports to, and the role and job title of the reports-to platform staff member.

The All System Users process launches a query displaying all system users, which may be sorted by type or other parameters. In one exemplary embodiment, this information includes, but is not limited to, the following: full name, login name, last login time, last remote IP address used to access the system, the number of total logins, and current user status.

The Search Objects process provides for compiling queries based on different objects or queries within the system. In one exemplary embodiment, these options include, but are not limited to, the following: list all objects, list all objects of a selected object type, list all available predefined queries, and specify new user-defined query.

The Documents section provides for producing or printing documents from system data, such as, but not limited to, lists of issuers or executives in the system. In one exemplary embodiment, this information includes, but is not limited to, the following: document selection type, existing query list, specify new query, designate query not called for, and choose to display the result or store the result in a file or document.

The Import process provides for the importation of data into the system. Imported data includes, but is not limited to, a list of issuers. In one exemplary embodiment, this information includes, but is not limited to, the following: select business object type to be imported, navigate to locally stored file for import, switch to designate file as a relationship file, validation switch, flag to create record if not found, and batch size designation (i.e., how many records to import from the given file at one time).

The Export process similarly provides for the exportation of data from the system, including relationship information for the selected data. In one exemplary embodiment, the user is prompted to select the data to export by selecting a list of all platform business objects, selecting an existing query, or creating and running a new query. The user also may be prompted to select which objects or attributes to export, such as, but not limited to, export identification numbers, larger documents and images, relationship data, all attributes, or only desired fields or attributes (e.g., AccountGroup, Accounts, Broker, CreatedBy, etc.)

The Recent Objects process displays a list of all recently accessed business objects, which may be regardless of object types. This process can function as a quick reference area for objects that users have recently worked on, and can be login (e.g., user) specific. In one exemplary embodiment, this information includes, but is not limited to, the following: business object type, platform level ID, and several fields for business object specific data.

The Active Processes section provides a way to view all currently running system processes. These processes differ from processes that can be launched for a particular business object. These processes often communicate with external systems to gather data (such as market data). Business object process, in contrast, gain access to areas of the system or perform certain actions within the system. In one exemplary embodiment, the active process information includes, but is not limited to, the following: name of the running process, process ID, time the process was started or launched, current status of the process, and current progress of the process, if applicable.

The Change Login Details process permits the editing of all login information. In one exemplary embodiment, this information includes, but is not limited to, the following: first name, last name, status, email address, role, job title, reporting relationships, access level, login name, change password function, system user who created the entry, entry date, import source, user who last modified the entry, and the date the entry was last modified.

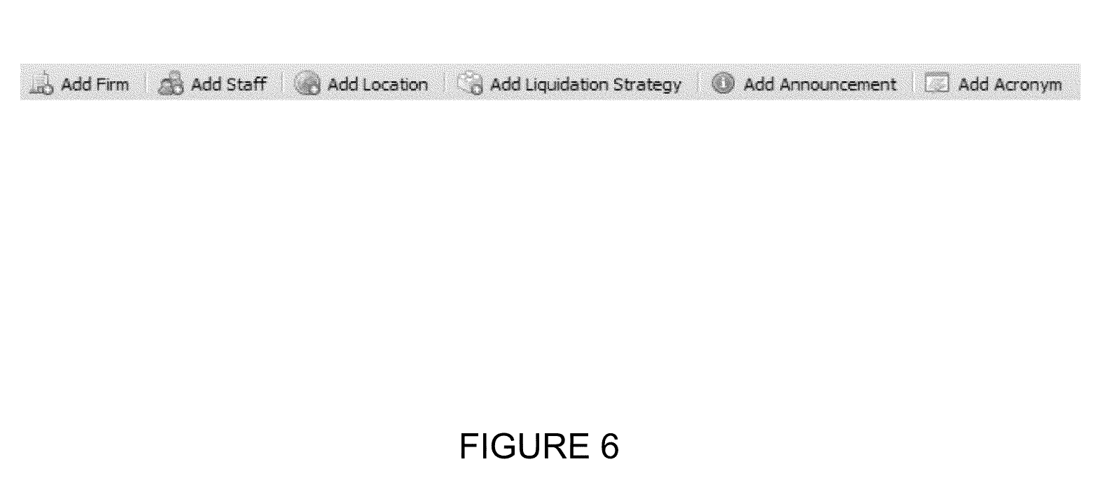

Platform functions are platform/system level actions available to a user working at the platform/system level. Each function available at the top of the platform level also is available at specific locations within the platform level. The top function bar, as seen in FIG. 6, serves as a shortcut bar to commonly used actions for the platform. In one embodiment, these functions include, but are not limited to, the following: Add Firm; Add Staff; Add Location; Add Liquidation Strategy; Add Announcement; and Add Acronym.

The Add Firm function launches the new firm entry screen. In one exemplary embodiment, this information includes, but is not limited to, the following: firm name, system assigned unique identification number, and current status (e.g., pending, active, inactive). A button or icon may be used to initiate a process for a firm logo to be uploaded.

The Add Staff process launches the new staff member entry screen. In one exemplary embodiment, this information includes, but is not limited to, the following: last name, first name, email address, current status, access level, login name, password, platform staff member the selected staff members reports to, and the role and job title of the reports-to platform staff member.

The Add Location function launches the new location entry screen. In one exemplary embodiment, this information includes, but is not limited to, the following: name of location, location code, status of the location, a detailed description, and the names and/or numbers of staff at the location.

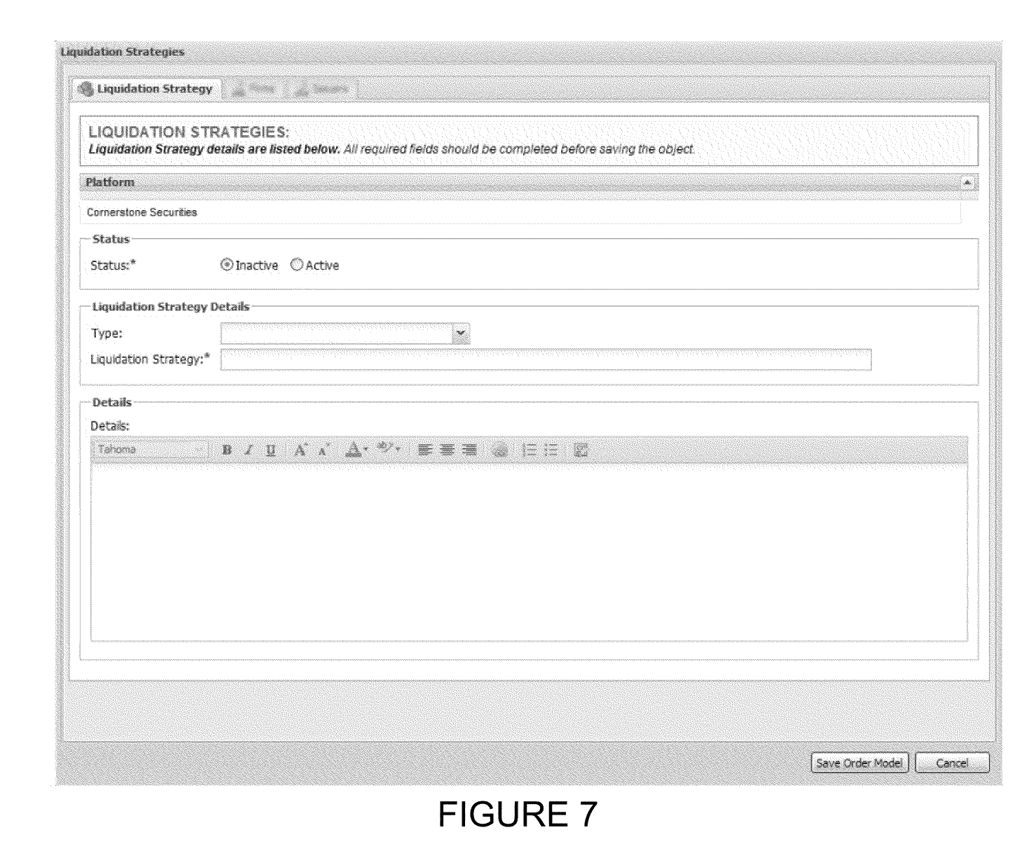

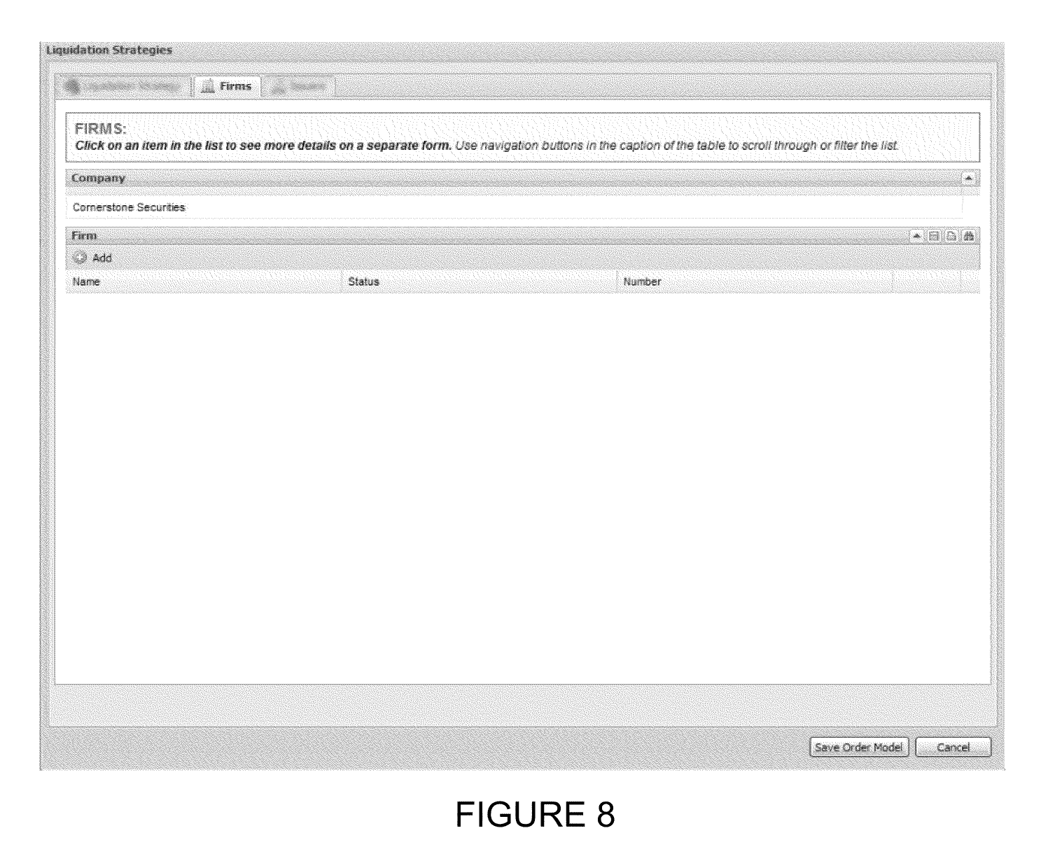

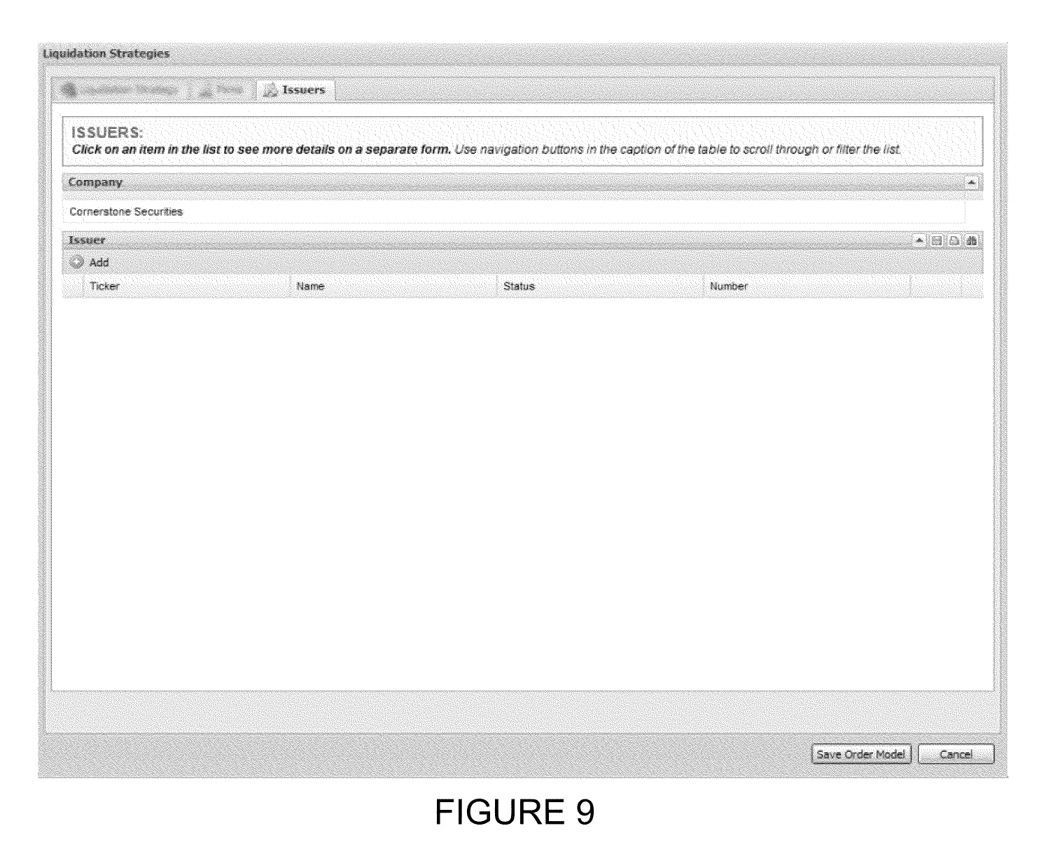

The Add Liquidation Strategy function launches the new liquidation strategy entry screen, as seen in FIG. 7. In one exemplary embodiment, this information includes, but is not limited to, the following: title of the strategy, name of the company, status of the new liquidation strategy (e.g., active, inactive), type of strategy, and detailed description of the strategy. The Firms tab in the Add Liquidation Strategy function provides the ability to view and add firms applicable to a particular liquidation strategy, as seen in FIG. 8. The Issuers tab provides the ability to view and add issuers applicable to a particular liquidation strategy, as seen in FIG. 9. In one exemplary embodiment, this information includes, but is not limited to, the following: name of the firm associated with this particular strategy, current firm status, firm identifier number, name of the issuer, current issuer status, issuer identifier number, and issuer ticker symbol.

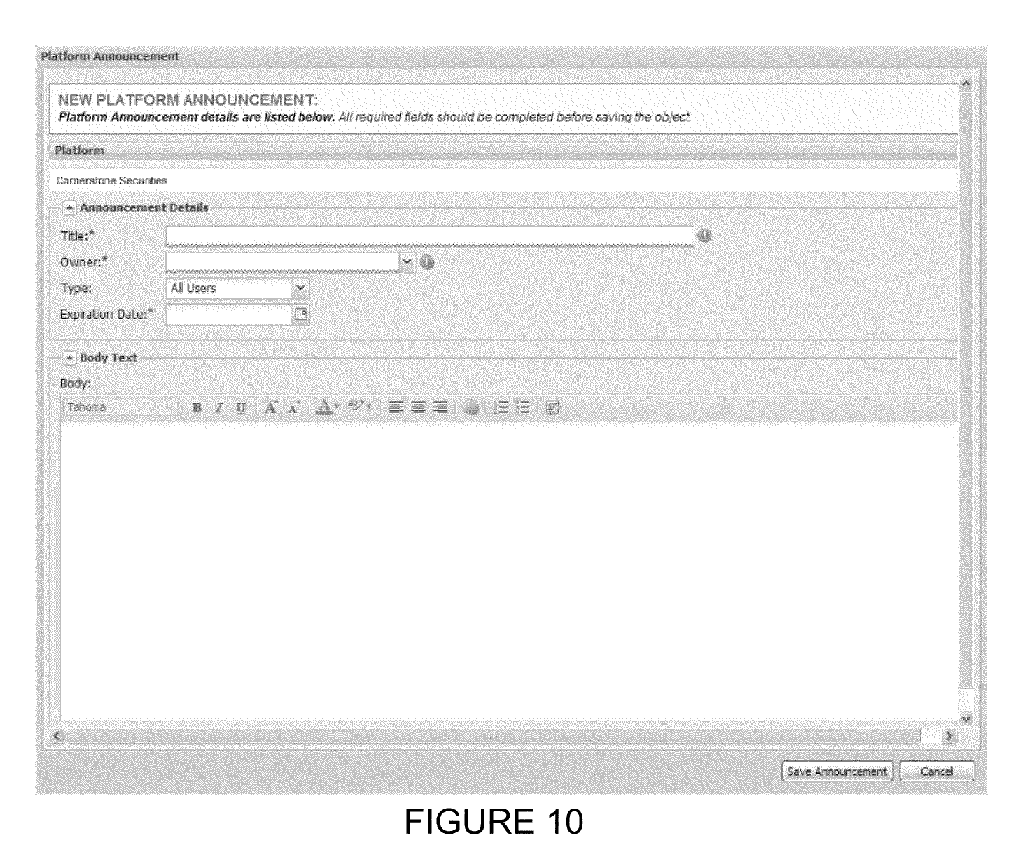

The Add Announcement function launches the new announcement entry screen, as seen in FIG. 10. In one exemplary embodiment, this information includes, but is not limited to, the following: title of announcement, name of the company, platform user that owns the announcement company or entity, expiration date of the announcement, and the body of the announcement.

The Add Acronym function launches the new acronym entry screen. In one exemplary embodiment, this information includes, but is not limited to, the following: name of the company, acronym (usually 3 letters) to be detailed, description or explanation of the acronym, type of acronym (e.g., industry, core business), and the department the acronym is applicable to (e.g., human resources, information technology).

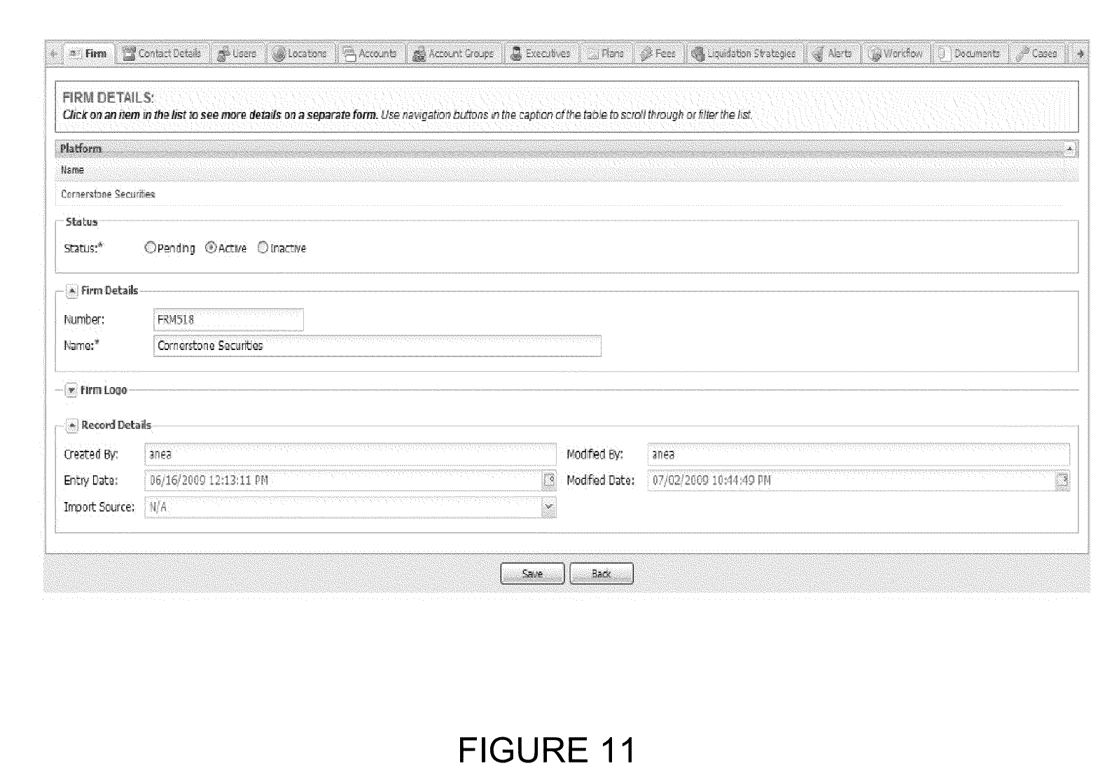

Similar to the Platform area, the Firm information area captures and represents all firm level data applicable to the creation and administration of trading plans. Different sections may be accessed through tabs, icons or buttons in the interface, as seen in FIG. 11. Firm areas include, but is not limited to, the following: firm details and information, contact details, user, location, accounts, account groups, executives, plans, fees, liquidation strategies, alerts, workflow, documents, cases, history, audit, and license agreements.

The Firm Details section, as seen in FIG. 11, provides for the capture and display of firm level details, such as status, name, and administrative information. In one exemplary embodiment, this information includes, but is not limited to, the following: name of firm, system assigned unique identification number, status, system user who created the firm entity, the date the firm entity was created, the system user who last modified the firm data, the date the firm data was last modified, and the source of the import data, if supplied.

The Contact Details section provides for the capture and designation of preferences for addresses and phone numbers associated to a firm entity. In one embodiment, each firm can have up to one address and phone number designed as the “main” address or phone number for that contact type. In one exemplary embodiment, this information includes, but is not limited to, the following: street, city, state, individual the address corresponds to, a flag to indicate whether address is the main address for the particular firm, the type of address (e.g., mailing, billing), a flag to indicate whether address-specific comments have been added, phone number, a flag to indicate whether the phone number is the main number for the particular firm, individual the phone number corresponds to, type of phone number (e.g., work, cell), and a flag to indicate whether phone number-specific comments haves been added.

The Users section provides for the display and addition of firm level users, such as a new broker brought into the firm. This section also is where the new user's access level may be set. In one exemplary embodiment, this information includes, but is not limited to, the following: full name, status, email address, and date the user was added.

The Locations section provides for tracking different locations applicable to the level. In one exemplary embodiment, this information includes, but is not limited to, the following: name of location, platform specific location code, and current location status.

The Accounts section displays all trading plan accounts associated with a firm. The information may be sorted by various parameters, including but not limited to account status. In one exemplary embodiment, this information includes, but is not limited to, the following: name of executive, name of account group, user-specified account number, broker assigned to the account, and account type (e.g. 10b5, settlements).

The Account Groups section provides for the classification of different account groups for ease of assignment to different firm users and management. In one exemplary embodiment, this information includes, but is not limited to, the following: account group name, user-defined account code identifier, account group split percentage, and calculated account group split percentage.

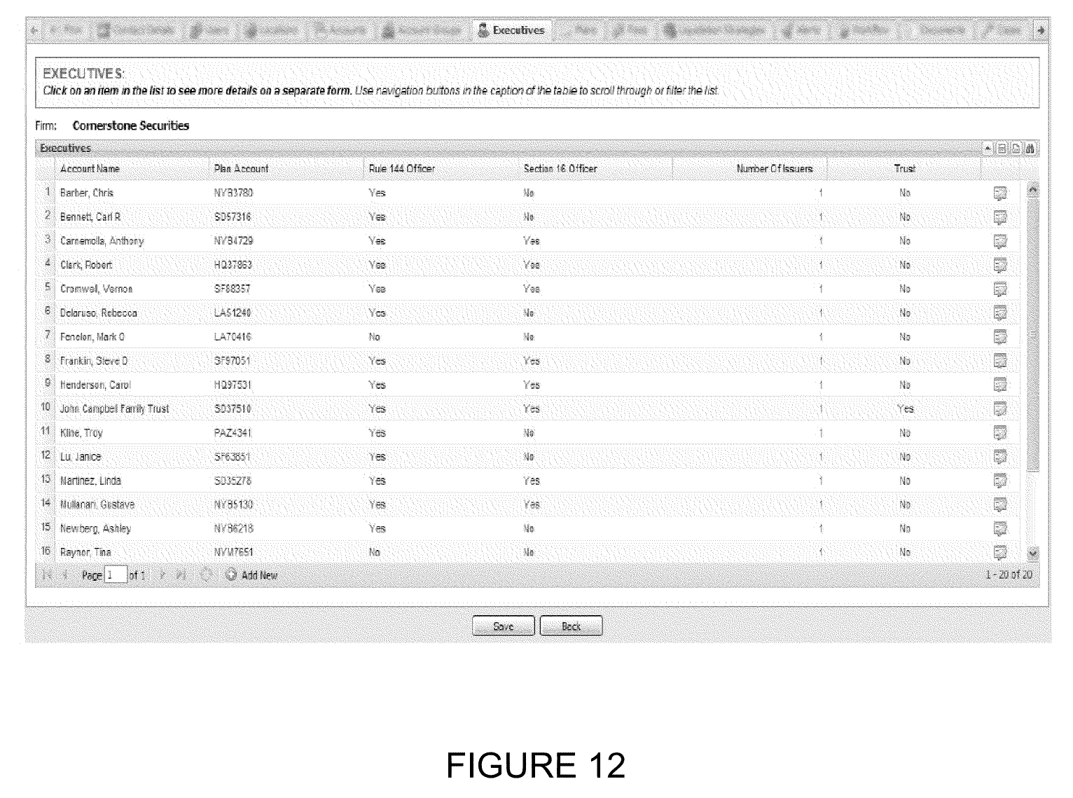

The Executives section, as seen in FIG. 12, displays executives currently assigned to a firm, and provides the ability to add executives to a firm. In one exemplary embodiment, this information includes, but is not limited to, the following: executive name, plan account number associated with the executive, Rule 144 officer classification, Section 16 insider officer classification (Section 16 refers to Section 16 of the Securities Exchange Act), number of issuers associated with the executive, and plan type classification.

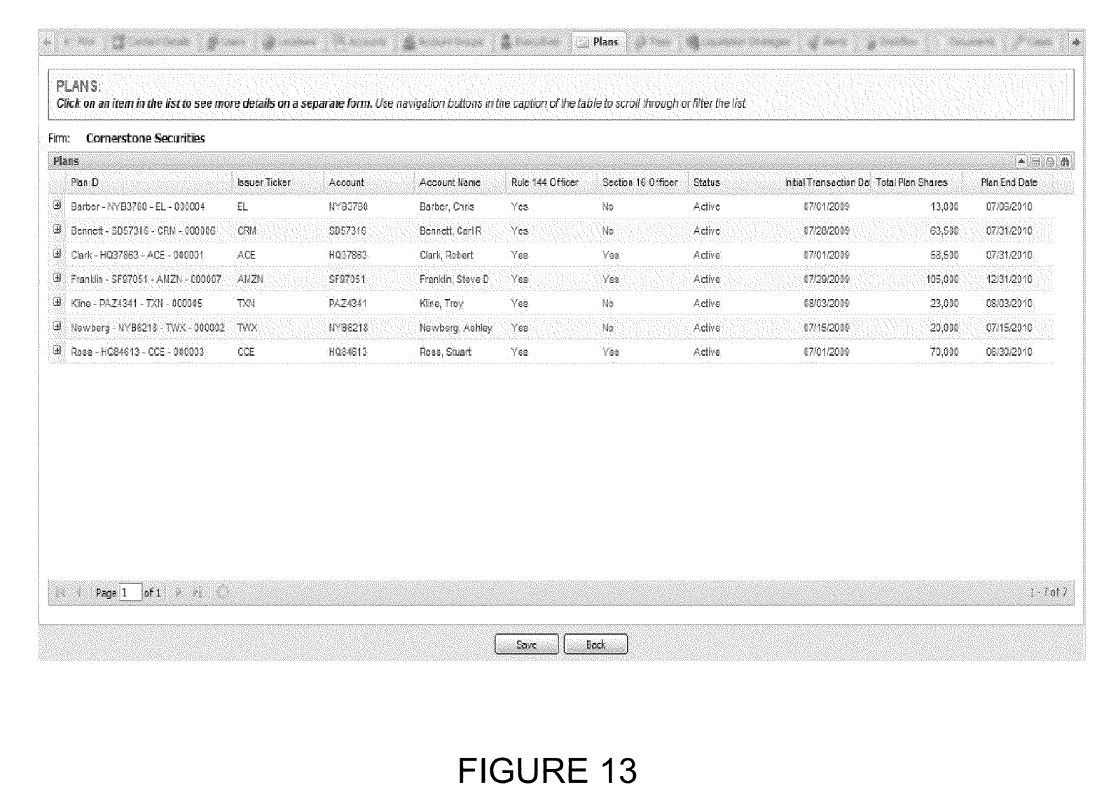

The Plans section, as seen in FIG. 13, provides a high level view of all plans for a selected firm. In one exemplary embodiment, this information includes, but is not limited to, the following: unique plan identifier (in one embodiment, this comprises executive last name, account number, issuer ticker symbol, and plan number), issuer ticker symbol, executive account ID, executive account name, flag indicating if the executive is classified as a Rule 144 officer, flag indicating if executive is classified as a Section 16 officer, status of the plan, date of the initial plan transaction, total shares associated with the plan, and the end date of the plan.

The Fees section displays all applicable fees associated with a firm. It also gives the ability to add additional or new fees. In one exemplary embodiment, this information includes, but is not limited to, the following: fee type (e.g., SEC fee, handling charge, etc.), value in US dollars, description of applicable calculations for the fee, the value range, and the fee value type (e.g., cents per share, percentage).

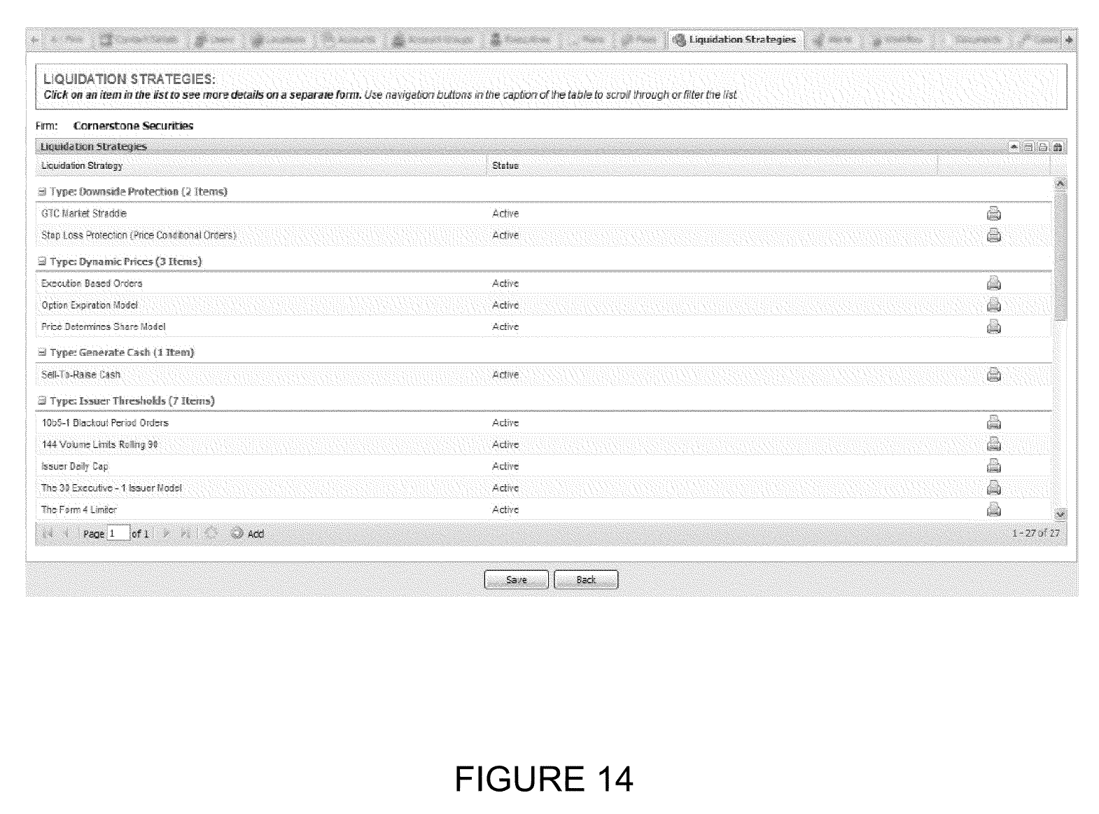

The Liquidation Strategies section, as seen in FIG. 14, provides for adding new or managing existing liquidation strategies at a firm level. The information may be sorted by various parameters, such as liquidation strategy types. In one exemplary embodiment, this information includes, but is not limited to, the following: liquidation strategy description, and current status.

The Alerts section provides a view of all firm level alerts currently in place. In one exemplary embodiment, this information includes, but is not limited to, the following: subject line of the alert, alert on switch, number of days between scheduled emails relating to the alert, the date the last email was sent in response to the alert, and the alert priority ranking.

The Workflow section provides the ability to assign and view current firm level required workflow procedures. In one exemplary embodiment, this information includes, but is not limited to, the following: name of the workflow entity, type of workflow entity, alert associated with the workflow entity, level specified for the workflow to be active, and order of the workflow.

The Documents section provides for the management of all firm level documentation related to plan administration, as well as other firm-specific documents. In one exemplary embodiment, this information includes, but is not limited to, the following: title of document, system user creating or adding the document, and the date the document was created or added.

The Cases section provides for the creation, viewing or editing of cases at the firm level of the system. As described above, cases fill the role of CRM service requests for a firm. In one exemplary embodiment, this information includes, but is not limited to, the following: case number, case title, case type (e.g., non-issue, problem, etc.), the system user the case is assigned to, the system user who opened the case, the date the case was opened, the date the case was closed, case priority (e.g., low, high, critical), and case status.

The History section provides for tracking of firm level historical data. In one exemplary embodiment, this information includes, but is not limited to, the following: history event type (e.g., phone call, meeting, etc.), date and time history event took place, direction (e.g., incoming, outgoing), description of the event, system user who created the entry, and the date set for a follow-up to the event.

The Audit section provides a view of all objects flagged for auditing at the firm level. Typically, these are objects that have been changed since the last audit. In one exemplary embodiment, this information includes, but is not limited to, the following: the business object ID, the business object name the change was implemented for, the user who completed the audit activity, the time the audit activity took place, and a detailed view of the audit record.

The License Agreement section displays all firm level license agreements. The information may be sorted by various parameters, such as status. In one exemplary embodiment, this information includes, but is not limited to, the following: license name, version number, date of agreement approval, number of the agreement, agreement type (e.g., broker, executive, etc.), and update number (automatically incremented to track successive changes to agreement record).

Firm processes are firm level actions available to a user working at the firm level. In one embodiment, these processes include, but are not limited to, the following: Find Firm; Add Firm; Add Account; Add Account Group; Add Executive; Add Document, Add Case; and Add History.

The Find Firm process launches a query displaying all firms in the platform. The information presented may include all firms, and results may be filtered. In one exemplary embodiment, this information includes, but is not limited to, the following: name of selected firm, current status, and system level unique identifier (which may be a number or an alphanumeric combination).

The Add Firm process launches the new firm entry screen. In one exemplary embodiment, this information includes, but is not limited to, the following: name of selected firm, current status, and system level unique identifier.

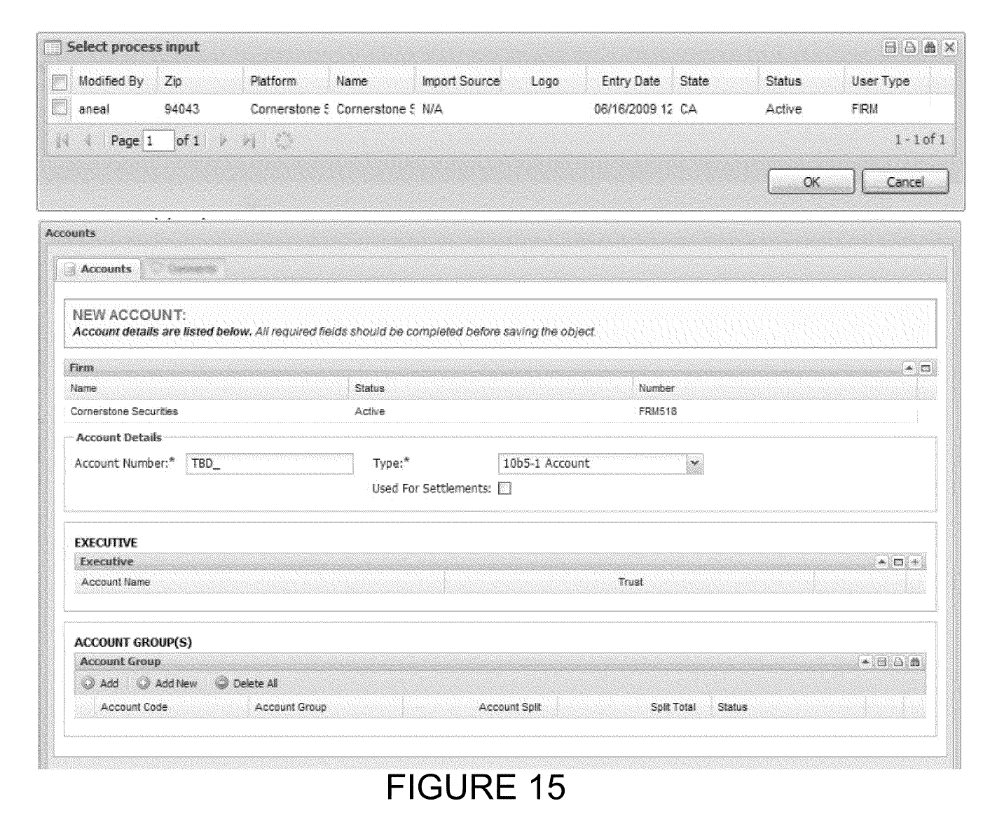

The Add Account process launches the new account creation process, as seen in FIG. 15. The user selects the firm the new account will be added to, then fills in the appropriate new account information. Comments may be added. In one exemplary embodiment, this information includes, but is not limited to, the following: name of selected firm, current status, system level unique identifier, account number, account type, flag for accounts used for settlement purposes, executive name for account, flag indicating whether executive is set as a trust account, account code, name of account group, account group split percentage, calculated account group split total, and status of the account group.

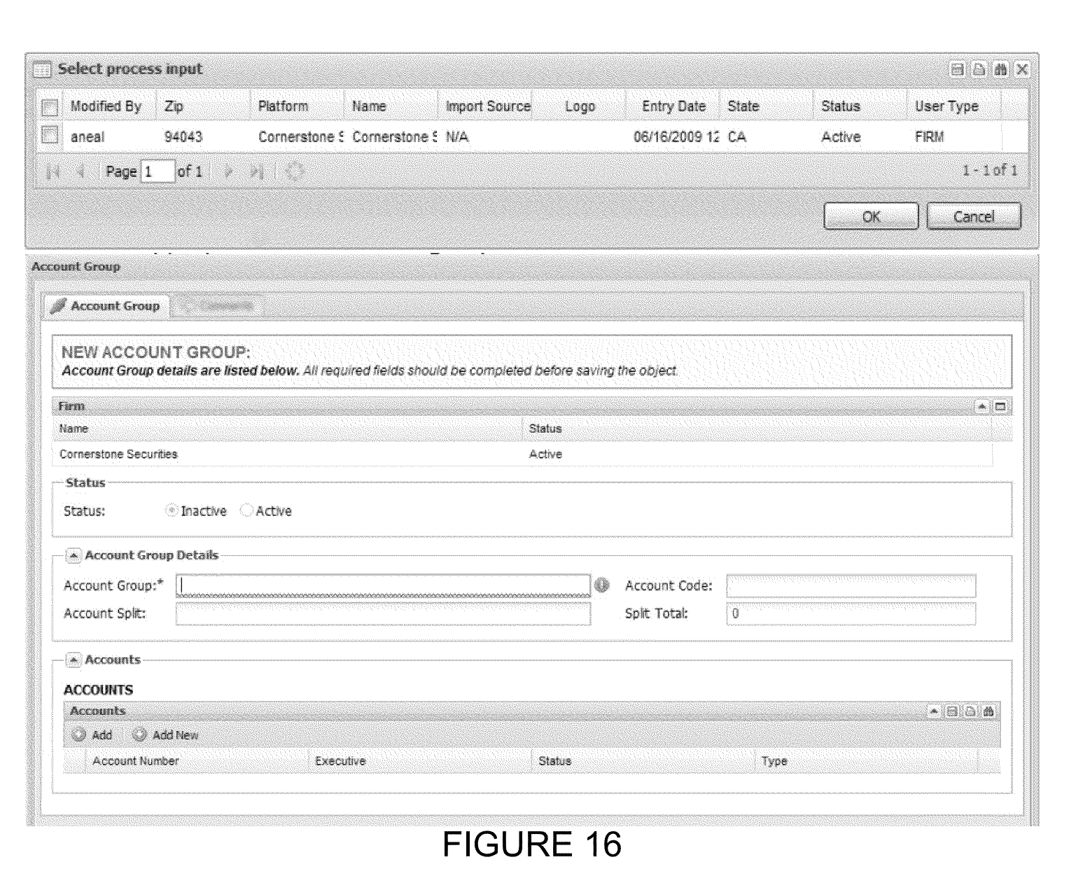

The Add Account Group process launches the new account group creation process, as seen in FIGS. 16. The user selects the firm the new account group will be added to, then fills in the appropriate new account group information. Comments may be added. In one exemplary embodiment, this information includes, but is not limited to, the following: name of selected firm, current status of firm, status of the new account, name of account group, account code, account group split percentage, calculated account group split total, account number, executive associated with the account, current status of the account, and type of account.

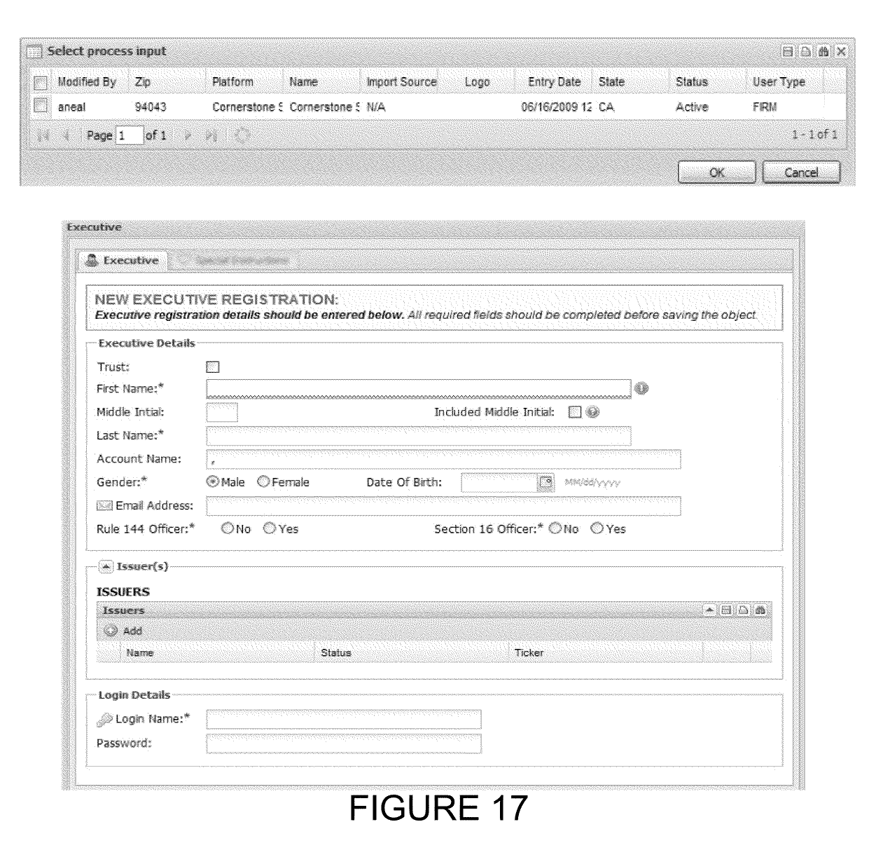

The Add Executive process launches the new executive creation process, as seen in FIG. 17. The user selects the firm the new executive will be added to, then fills in the appropriate new executive information. Special instructions may be added. In one exemplary embodiment, this information includes, but is not limited to, the following: executive last name, first name, middle initial, suffix, trust name, account name, executive gender, date of birth, email address, Rule 144 officer flag, Section 16 officer flag, name of issuer, status of issuer, issuer ticker symbol, executive login name, and password.

In a similar fashion, the Add Document process launches the new document creation process. The user selects the firm the new document will be added to, then fills in the appropriate new document information. In one exemplary embodiment, this information includes, but is not limited to, the following: title of document, general document type (e.g., contract, account paperwork, etc.), attachment window (to open and upload document), and document description.

The Add Case process similarly launches the new case creation process. The user selects the firm the new case will be added to, then fills in the appropriate new case information. Case attachments may be added. In one exemplary embodiment, this information includes, but is not limited to, the following: case title, case status, case type, system user who opened the case, case priority, the date the case was opened, and a detailed description of the case.

The Add History process launches the new history entry creation process. The user selects the firm the new history entry will be added to, then fills in the appropriate new history entry information. In one exemplary embodiment, this information includes, but is not limited to, the following: firm name the history record is being created for, firm status, date and time the history event took place, history type, subject of the event, direction, detailed description of history event, date set for follow-up, follow-up completion date, name of follow-up user, status of follow-up, job title of follow-up user, and system identifier for follow-up user.

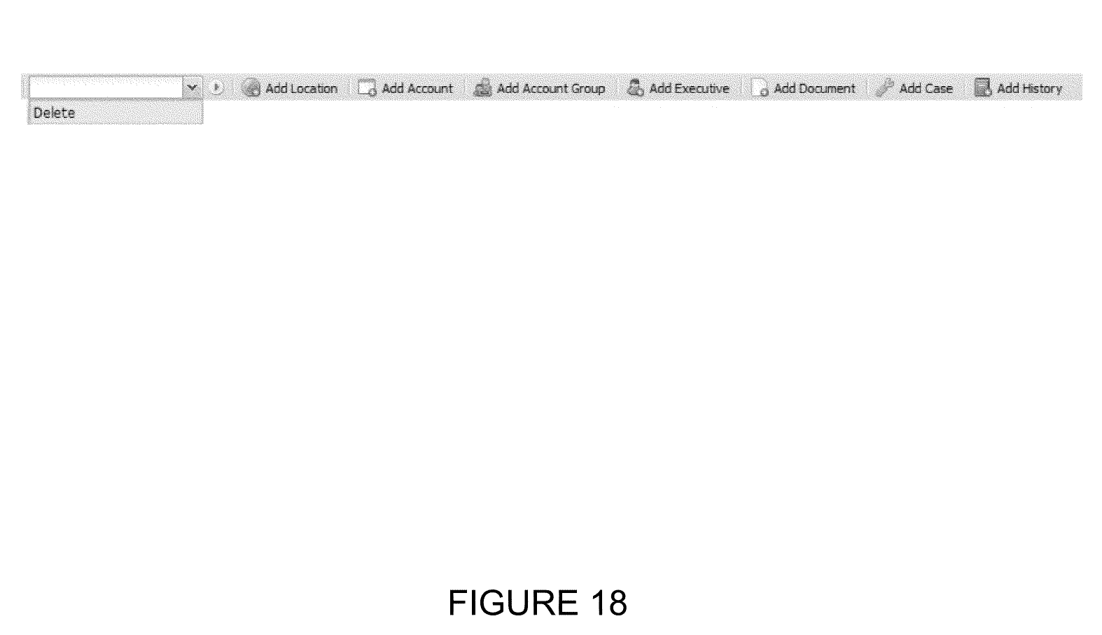

Firm functions are firm level actions available to a user working with a selected firm. Each function available at the top of the firm level also is available at specific locations within the firm level. The top function bar, as seen in FIG. 18, serves as a shortcut bar to commonly used actions for a firm. In one embodiment, these functions include, but are not limited to, the following: Delete Firm; Add Location; Add Account; Add Account Group; Add Executive; Add Document; Add Case; and Add History.

The Delete function deletes the currently selected firm from the system. Once initiated, the user will be promoted to confirm the deletion.

The Add Location function launches the new location entry screen for the firm. In one exemplary embodiment, this information includes, but is not limited to, the following: location name, location code, location status, detailed description of location, and identification numbers of staff members at that location.

The Add Account process launches the new account creation process. The user fills in the appropriate new account information. Comments may be added. In one exemplary embodiment, this information includes, but is not limited to, the following: name of selected firm, current status, system level unique identifier, account number, account type, flag for accounts used for settlement purposes, executive name for account, flag indicating whether executive is set as a trust account, account code, name of account group, account group split percentage, calculated account group split total, and status of the account group. Options may include the selection and addition of existing of existing of additional accounts.

The Add Account Group process launches the new account group creation process. The user fills in the appropriate new account group information. Comments may be added. In one exemplary embodiment, this information includes, but is not limited to, the following: name of selected firm, current status of firm, status of the new account, name of account group, account code, account group split percentage, calculated account group split total, account number, executive associated with the account, current status of the account, and type of account.

The Add Executive process launches the new executive creation process. The user fills in the appropriate new executive information. Special instructions may be added. In one exemplary embodiment, this information includes, but is not limited to, the following: executive last name, first name, middle initial, suffix, trust name, account name, executive gender, date of birth, email address, Rule 144 officer flag, Section 16 officer flag, name of issuer, status of issuer, issuer ticker symbol, executive login name, and password.

In a similar fashion, the Add Document process launches the new document creation process. The user fills in the appropriate new document information. In one exemplary embodiment, this information includes, but is not limited to, the following: title of document, general document type (e.g., contract, account paperwork, etc.), attachment window (to open and upload document), and document description.

The Add Case process similarly launches the new case creation process. The user fills in the appropriate new case information. Case attachments may be added. In one exemplary embodiment, this information includes, but is not limited to, the following: case title, case status, case type, system user who opened the case, case priority, the date the case was opened, and a detailed description of the case.

The Add History process launches the new history entry creation process. The user fills in the appropriate new history entry information. In one exemplary embodiment, this information includes, but is not limited to, the following: firm name the history record is being created for, firm status, date and time the history event took place, history type, subject of the event, direction, detailed description of history event, date set for follow-up, follow-up completion date, name of follow-up user, status of follow-up, job title of follow-up user, and system identifier for follow-up user.

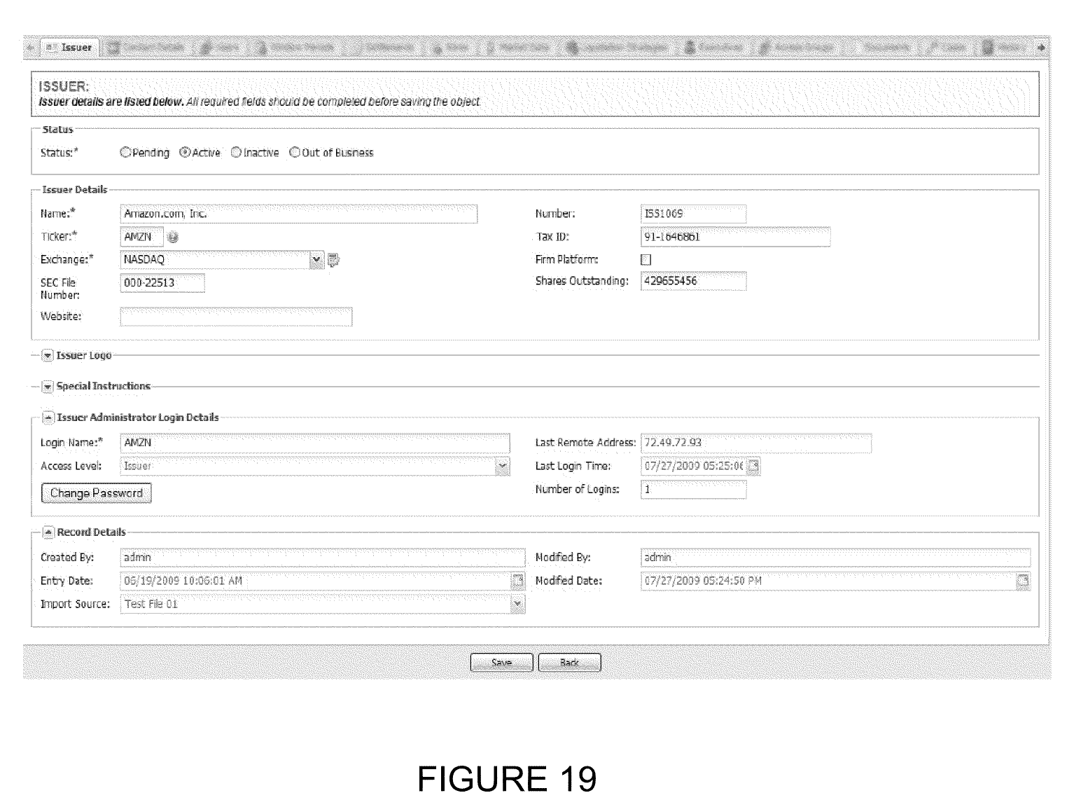

The Issuer level of the system provides for the capture, tracking, and storage of all items related to an issuer's trading plans. An exemplary embodiment of a user interface for this level is shown in FIG. 19. In one exemplary embodiment, sections include, but are not limited to, Issuer Details, Contact Details, Users, Windows Periods, Settlements, Wires, Market Data, Liquidation Strategies, Executives, Access Groups, Documents, Cases, History, Audit, and License Acceptance.

The Issuer Details section, as seen in FIG. 19, provides for the capture and display of issuer level details. In one exemplary embodiment, this information includes, but is not limited to, the following: issuer name, issuer ticker symbol, issuer status, name of the exchange the issuer is traded on (e.g., NYSE, NASDAQ, etc.), the SEC assigned filed number for the issuer, issuer website address, system assigned issuer specific identifier, issuer tax ID number, flag indicating whether other equity administration is handled by the firm, issuer shares outstanding, issuer logo, special instructions related to the issuer, issuer administrator login details (name, access level, last remote IP address used to login, last login time, total number of logins), and record details (system user who created issuer entity, date entered into the system, source of issuer data imported, date last modified, and user who last modified the issuer entry.

The Contact Details sections provides for the capture and designation of preferences for addresses and phone numbers associated with an issuer. Each issuer can have only one main address and one main phone number. In one exemplary embodiment, this information includes, but is not limited to, the following: address (street, city, state), type of address, flag for main address for the issuer, flag for whether address is used on Form 144, the individual the address corresponds to, flag indicating whether address specific comments have been added to the entry, phone number, extension, type of phone number, flag for main phone number for the issuer, and flag indicating whether phone number specific comments have been added to the entry.

The Issuer Users section provides for the display and addition of issuer level users and related information. In one exemplary embodiment, this information includes, but is not limited to, the following: user name, unique identifier, user type (e.g., legal, human resources, etc.), flag for whether user is designated as main contact for user, and current user status.

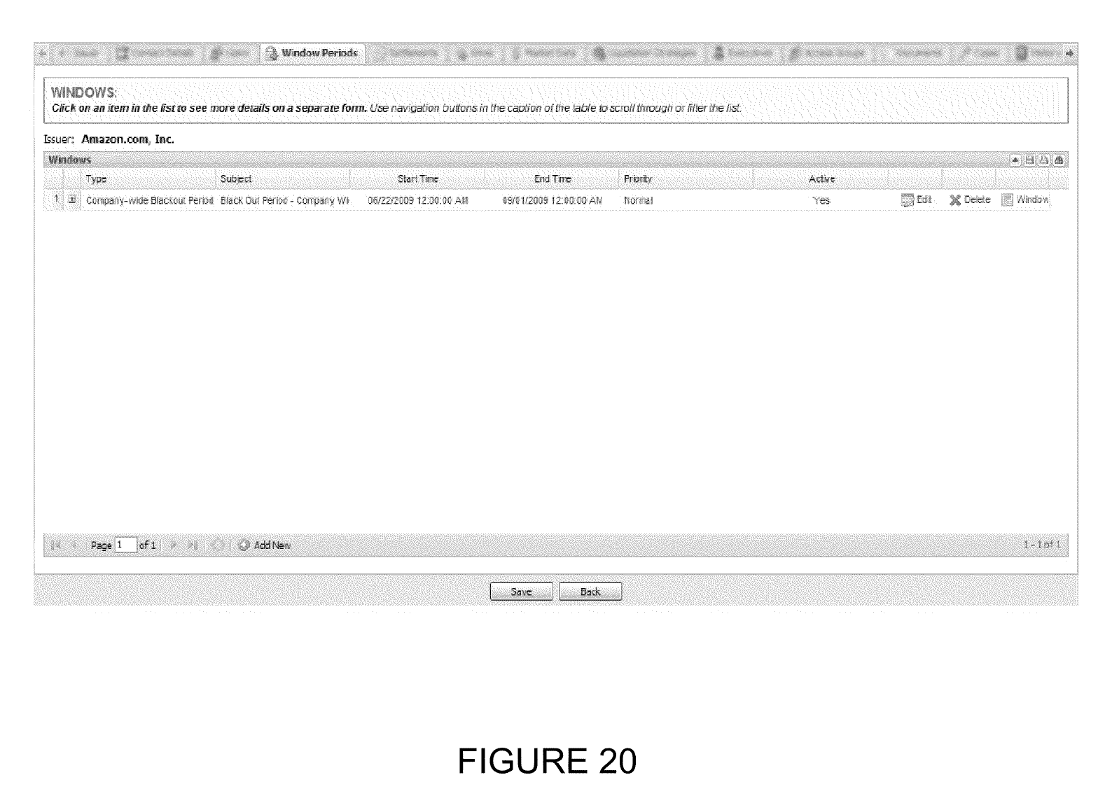

The Windows Periods section, as seen in FIG. 20, provides an area to enter issuer blackout periods. The windows periods visible within the specific issuer's calendar can be applied to order calculations at the time of plan creation. In one exemplary embodiment, this information includes, but is not limited to, the following: windows period type description (e.g., platform-wide blackout period, emergency window, etc.), description of window period, date the window period starts, date the window ends, priority level (e.g., low, normal, etc.), and current status of the window period. Other options include editing and deleting the selected record, and displaying the selected window period in calendar format.

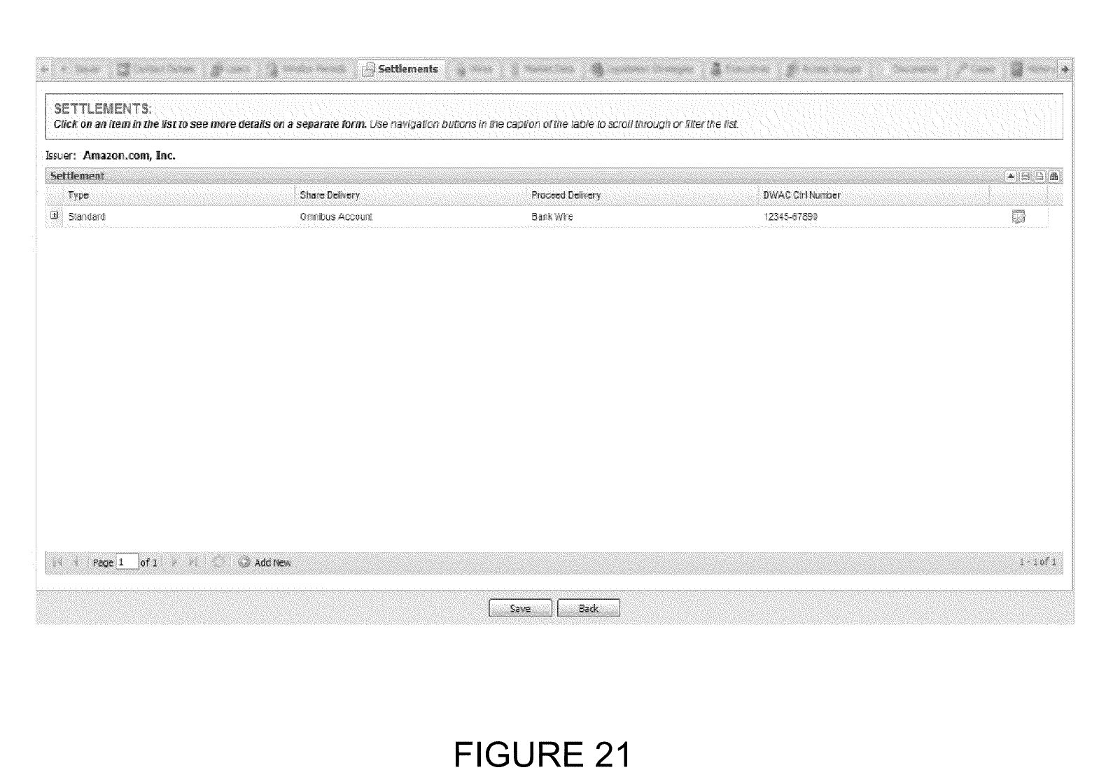

The Settlements section, as seen in FIG. 21, has specific information relating to processing settlements with the issuers. In one exemplary embodiment, this information includes, but is not limited to, the following: type of settlement (e.g., standard, non-standard), the share delivery method (e.g., DWAC (deposit/withdrawal at custodian), omnibus account), proceeds delivery method (e.g., bank wire, journal), and DWAC control number.

The Wires section provides for capturing issuer specific bank transfer information. In one exemplary embodiment, this information includes, but is not limited to, the following: bank name, bank ABA routing number, bank account number, bank account type (e.g., USD, Euro), IBAN (international bank account number) code, and type of wire (e.g., 10b5-1 proceeds, taxes).

The Market Data section displays market data for the selected issuer, and the information may be sorted by a variety of parameters. In one exemplary embodiment, this information includes, but is not limited to, the following: date the market data values occurred, time the market data occurred, the closing price for the prior day, the opening price on a given date, the closing price on a given date, the difference between the opening and closing price, the stocks high price and low price on a given date, the stock price range in the last 52 week period, and the number of shares traded on a given date.

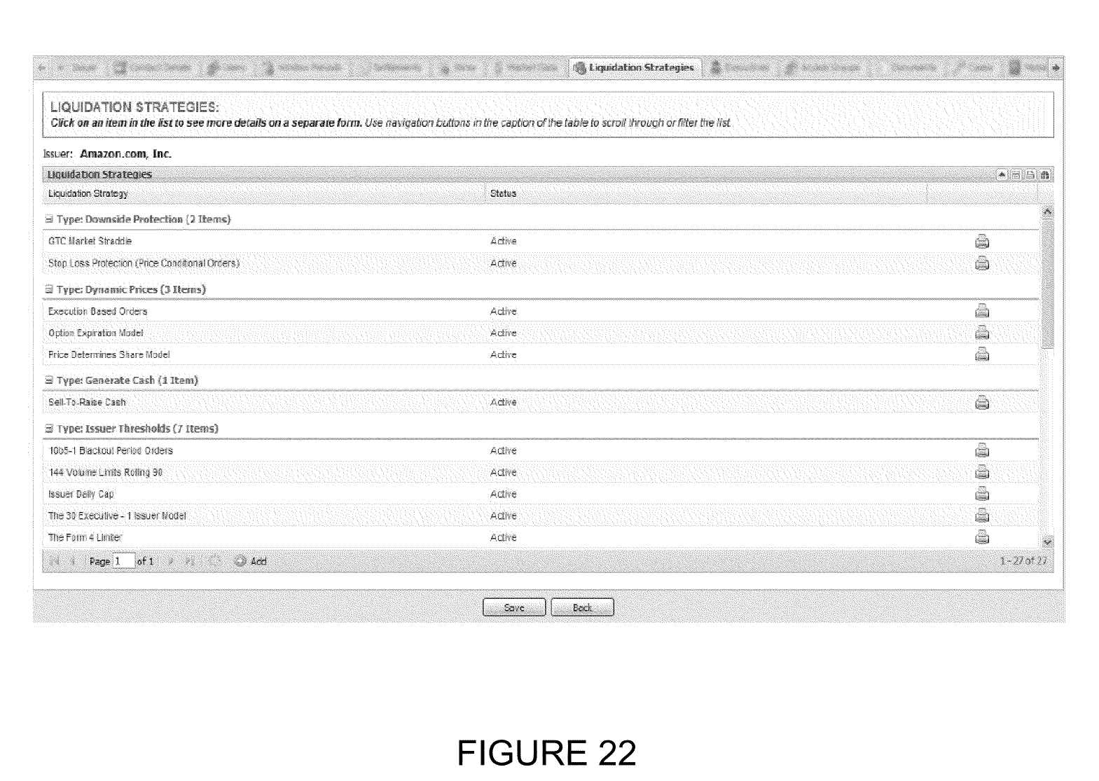

The Liquidation Strategy section, as seen in FIG. 22, provides for adding new or managing existing litigation strategies. Each liquidation strategy is specifically designed to meet different liquidation needs. The system has alerts to assist with the management of each order. The information may be sorted by a variety of parameters, including liquidation strategy type. In one exemplary embodiment, this information includes, but is not limited to, the following: title of the liquidation strategy, and current liquidation strategy status.

The Executives section displays executives currently assigned to an issuer, and provides for adding executives to an issuer. In one exemplary embodiment, this information includes, but is not limited to, the following: executive name, Rule 144 officer classification, Section 16 insider officer classification, and plan type (trust) classification.

The Access Groups section provides a view of all issuer access views. The access view provides access to certain executive's accounts for the issuer users. In one exemplary embodiment, this information includes, but is not limited to, the following: access group name, and group status (e.g., active, inactive).

The Documents section provides for management of all issuer level documentation related to plan administration, and other issuer related documents. In one exemplary embodiment, this information includes, but is not limited to, the following: title of document, system users who added the document to the system, and the date the document was added to the system.

The Cases section provides for creating, viewing, and editing cases at the issuer level. It functions in a similar manner to the Cases sections discussed above. In one exemplary embodiment, this information includes, but is not limited to, the following: user originating the case, case number, case title, date case first entered into system, case priority level (e.g., low, high, critical, etc.), case type (e.g., non-issue, problem, etc.), and current case status.

The History section provides for the tracking of issuer level historical data. It functions in a similar manner, with similar information and data, to the History sections discussed above.

The Audit section provides a view into all objects flagged for auditing at the issuer level that have been changed. It functions in a similar manner, with similar information and data, to the Audit sections discussed above.

The License Acceptance section displays all issuer level license agreements accepted and sorted by their status, or other parameters. It functions in a similar manner, with similar information and data, to the License Agreement section discussed above.

Issuer Processes are available at the issuer level to locate and add issuers, and add issuer window periods. These are contrasted with Issuer Functions, which are issuer level actions performed while working with a selected issuer. Corresponding processes and functions operate similarly.

In one exemplary embodiment, Issuer Processes include, but are not limited to, Find Issuer, Add Issuer, Issuer Window Periods, Add Access Group, Add Window Period, Add Document, Add Case, Add History, and 10K/10Q Search.

The Find Issuer process launches a query displaying all issuers within the system. In one exemplary embodiment, this information includes, but is not limited to, the following: issuer name, issuer current status, issuer ticker symbol, name of the exchange the issuer is traded on, flag indicating whether other equity administration is handled by the firm, the last system user to modify the issuer record, date of last modification, the issuer website, and unique identifier for the issuer (numeric, or alphanumeric).

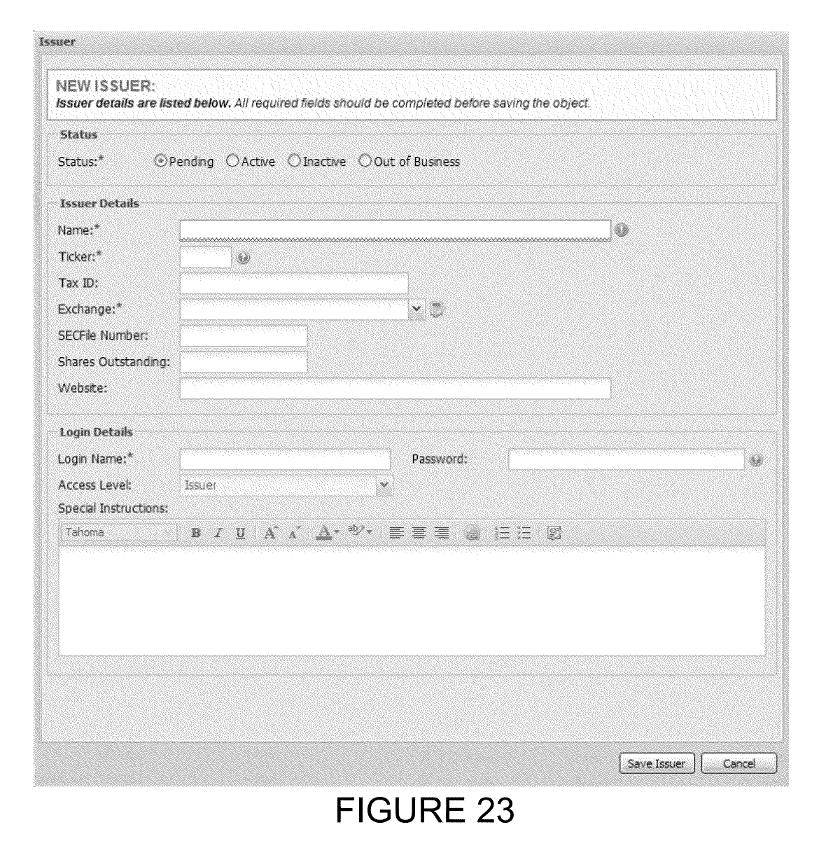

The Add Issuer process launches the New Issuer entry screen, as seen in FIG. 23, where a user can enter new issuer information. In one exemplary embodiment, this information includes, but is not limited to, the following: name of issuer, current status, exchange-specific issuer ticker symbol, issuer tax ID number, name of the exchange the issuer is traded on, SEC-assigned file number for the issuer, issuer shares outstanding, issuer website address, issuer login name, access level for issuer login, password, and special instructions that may be related to the issuer.

The Issuer Window Periods displays a calendar that contains issuer window periods. The calendar has different display options (e.g., daily, weekly, monthly, etc.). Users may click on a particular calendar entry to open it up in edit mode.

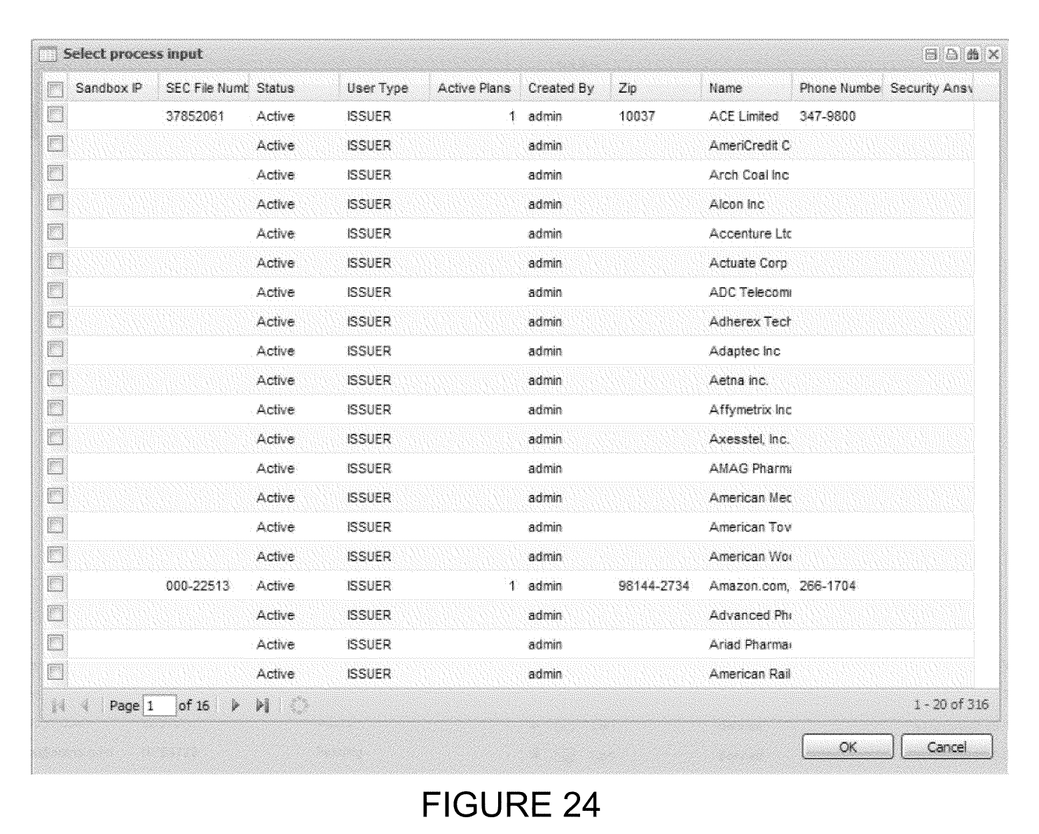

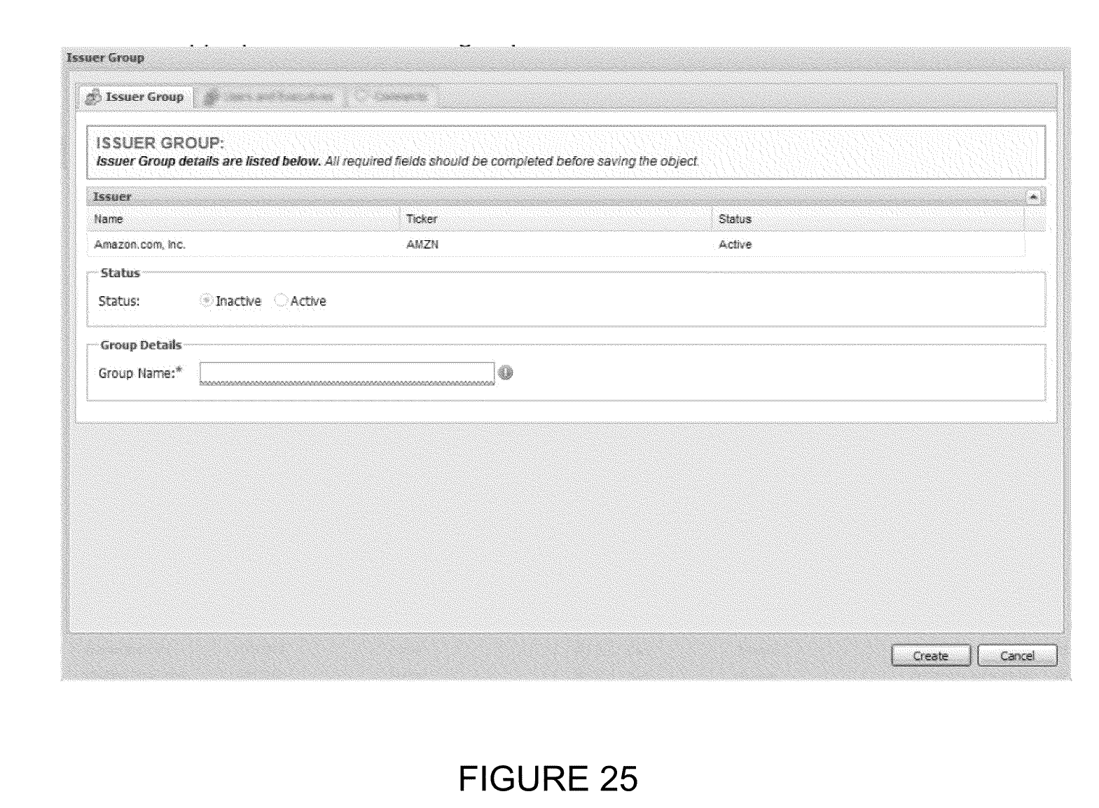

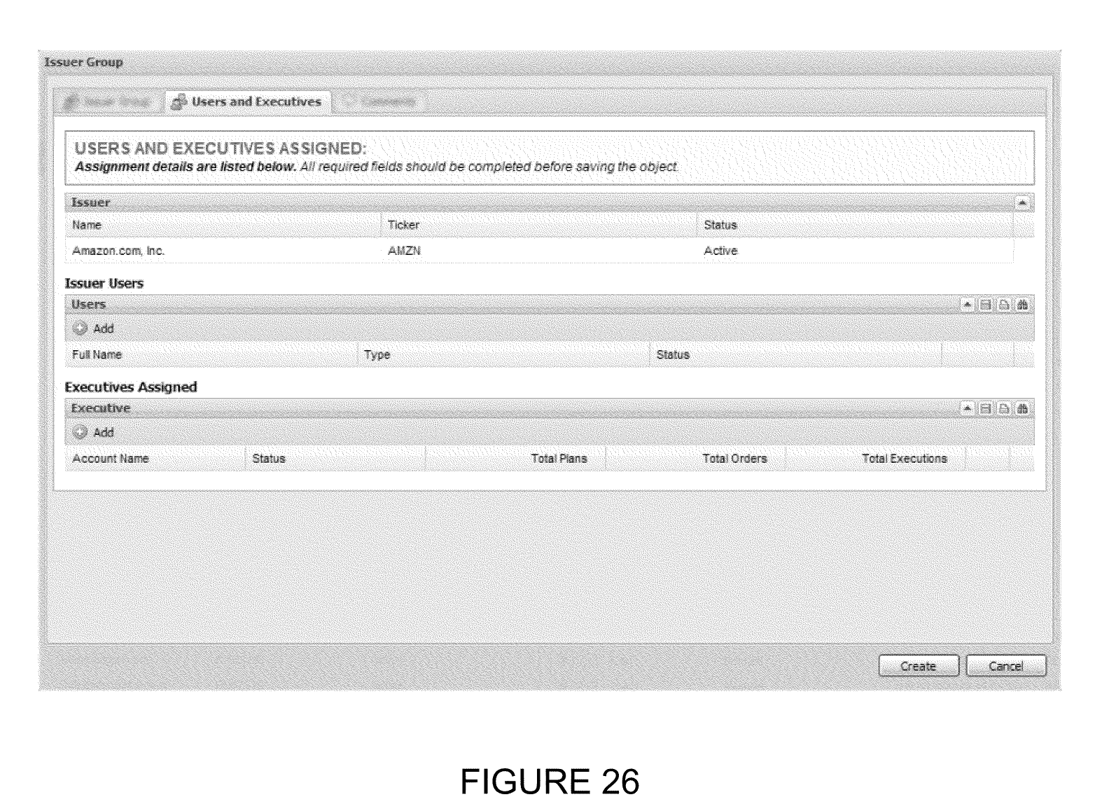

The Add Access Group process launches the new access group creation process. First, the user selects the issuer that the new access group will be added, as seen in FIG. 24, then fills in the appropriate new access group information, as seen in FIG. 25. A separate screen is used to assign users and executives, as seen in FIG. 26. Group comments may be added. In one exemplary embodiment, this information includes, but is not limited to, the following: issuer name, issuer ticker symbol, issuer status, status of the new access group, name of the new access group, name of the issuer user, user type, user status, name of the executive associated to the account, executive status, number of plans within the system specific to the executive, total number of orders applicable to the executive, and the number of executions applicable to the executive.

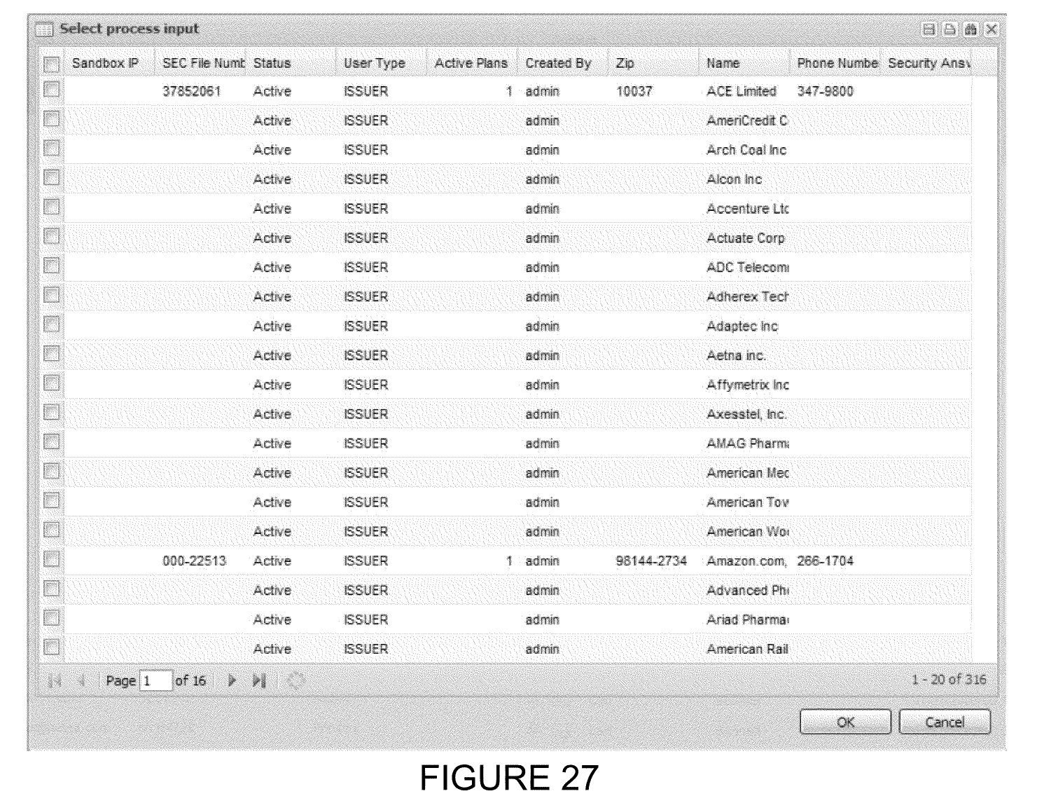

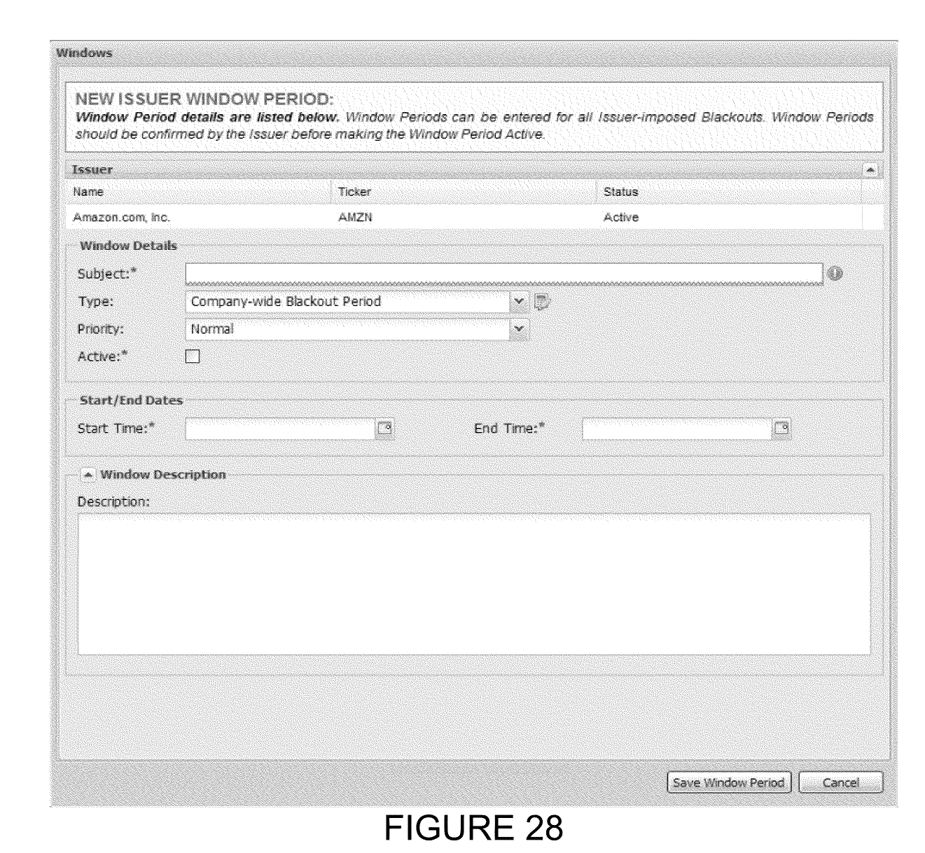

The Add Window Period process launches the new window period creation process. The user first selects the issuer that the new window period will be added to, as shown in FIG. 27, then fills in the appropriate new window period information, as shown in FIG. 28. In one exemplary embodiment, this information includes, but is not limited to, the following: issuer name, exchange specific issuer ticker symbol, current issuer status, title of window period, window type description (e.g., platform-wide blackout period, emergency window), window priority level (e.g., low, normal, high, etc.), current status of the window, window start date and end date, and a detailed description of the window period.

The Add Document process launches the new document creation process. First, the user selects the issuer that the new document will be added to, then fills in the appropriate document information. In one exemplary embodiment, this information includes, but is not limited to, the following: document title, name of issuer owning the document, description of the document, and general document type specification. The document may be uploaded and attached to the record.

The Add Case process launches the new case creation process. First, the user selects the issuer that the new case will be added to, then fills in the appropriate new case information. Documents or other materials may be attached to the case (and can be displayed as a thumbnail with the record). In one exemplary embodiment, this information includes, but is not limited to, the following: case title, case status, case type, user that opened the case, case priority, date the case was opened, and detailed description of the case.

The Add History process launches the new history creation process. This functions similarly to, and uses similar data and information as, the Add History processes described above. First, the user selects the issuer that the new history will be added to, then fills in the appropriate new history information.

The Issuer 10K/10Q Search function launches the SEC database, taking the user to the issuer-specific filings. The user simply selects the issuer to perform the search on.

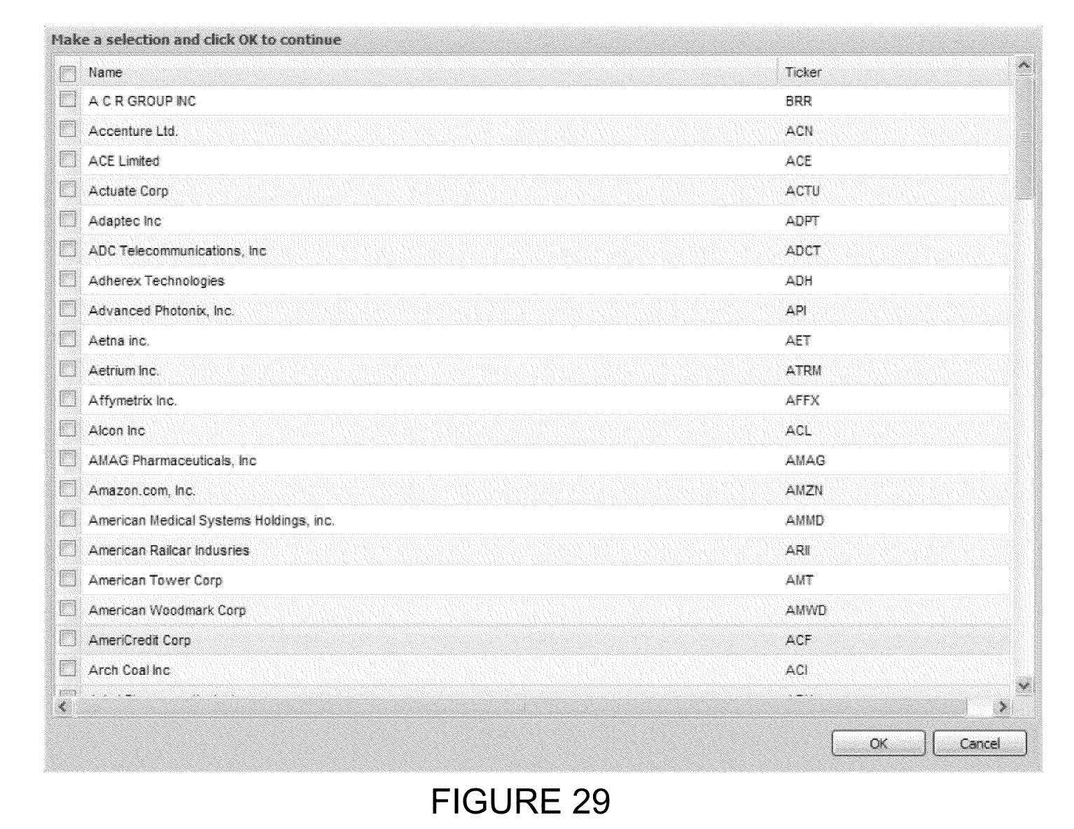

Issuer functions are issuer level actions that can be performed while working with a selected issuer. As shown in FIG. 29, each function that is available at the top of the issuer level is also available at specific locations within the issuer level. The top function bar serves as a short cut bar to commonly used actions for the issuer. Functions include Delete Issuer, Add User, Add Window Period, Add Access Group, Add Document, Create Case, Add History, and 10K/10Q Search.

The Delete Issuer functions permits the deletion of the currently selected issuer. Users may be prompted with a confirmation message prior to the issuer being deleted from the system.

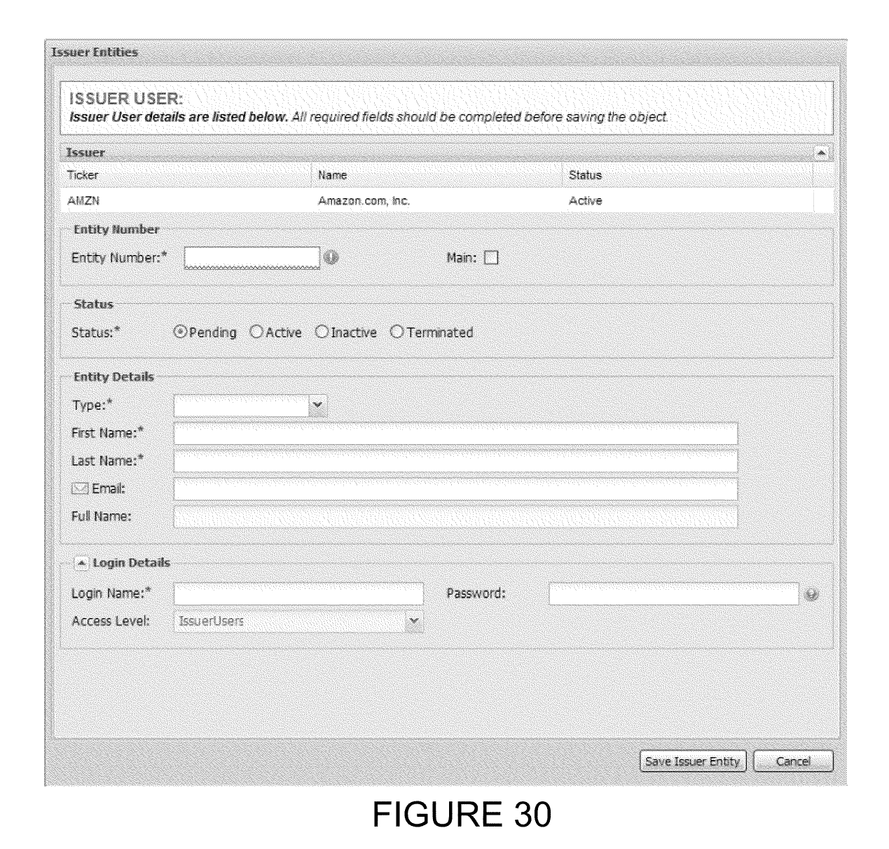

The Add User function opens the new issuer specific user entry screen, as seen in FIG. 30. The information and data is similar to that for other Add User functions, as described above.

The Add Window Period function opens the new window period entry form. In one exemplary embodiment, this information includes, but is not limited to, the following: issuer name, exchange specific issuer ticker symbol, current issuer status, title of window period, window type description (e.g., platform-wide blackout period, emergency window), window priority level (e.g., low, normal, high, etc.), current status of the window, window start date and end date, and a detailed description of the window period.

The Add Access Group function opens the new access group information and user/executive assigned forms. Group comments may be added. In one exemplary embodiment, this information includes, but is not limited to, the following: issuer name, issuer ticker symbol, issuer status, status of the new access group, name of the new access group, name of the issuer user, user type, user status, name of the executive associated to the account, executive status, the number of plans within the system specific to the executive, total number of orders applicable to the executive, and the number of executions applicable to the executive.

The Add Document function adds a document to the selected issuer entity. In one exemplary embodiment, this information includes, but is not limited to, the following: document title, name of issuer owning the document, description of the document, and general document type specification. The document may be uploaded and attached to the record.

The Create Case function launches the new case entry form. The user fills in the appropriate new case information. Documents or other materials may be attached to the case (and can be displayed as a thumbnail with the record). In one exemplary embodiment, this information includes, but is not limited to, the following: case title, case status, case type, user that opened the case, case priority, date the case was opened, and detailed description of the case.

The Add History function launches the new history entry form. This functions similarly to, and uses similar data and information as, the Add History processes described above.

The 10K/10Q search function launches the SEC database, taking the user to the issuer specific filings.

The Executive level of the system allows firm clients (executives) to securely access the system to create their trading plan or plans, download and print plan-related document, track the plan's progress, and obtain execution details.

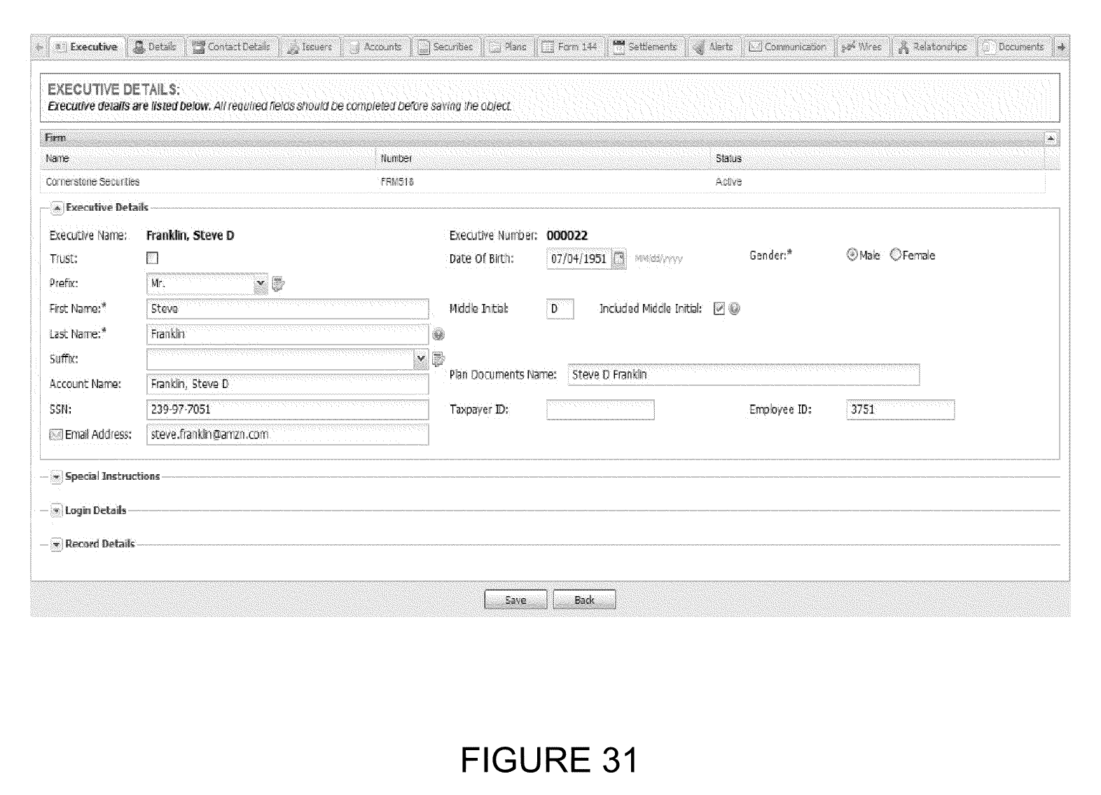

FIG. 31 shows an exemplary embodiment of a user interface to access various areas of the Executive level. Areas includes, but are not limited to, Executive Details, Contact Details, Issuers, Accounts, Securities, Plans, Form 144, Settlements, Alerts, Communication, Wires, Relationships, Documents, Cases, History, Audit and License Agreement. Many of these areas are similar to the areas for other levels discussed above, and use the same data or information. These areas include Contact Details, Issuers, Accounts, Settlements, Alerts, Wires, Documents, Cases, History, Audit, and License Agreement. Each of these areas, when activated, display screens similar to these areas in other levels, prompting the user to enter or review data or information. The Executive Details, Securities, Plans, Form 144, Communication, and Relationships areas are discussed in more detail below.

The Executive Details area provides for capturing and displaying executive status, demographic details, login information, and record details, as seen in FIG. 31. In one exemplary embodiment, this information includes, but is not limited to, the following: name of the firm, unique firm identifier, firm status, executive name (prefix, suffix, last name, first name, middle initial), name of trust, account name, social security number, email address, unique executive identifier, date of birth, gender, flag to indicate if middle initial will be included in the platform calculations, the name that will be automatically assigned to plan documentation, the executive entity taxpayer identification number, the system-specific employee identification number, special instructions with regard to the executive, executive login ID, access level, password, flag to indicate if executive has accepted the license agreement for the system, the last remote IP address used by the executive to log into the system, the date and time of the last login, the total number of times the executive has logged into the system, the system user that created the executive entry, the date the executive entry was entered into the system, the source of the import of executive data (if any), the system user that last modified the executive data, and the date of last modification.

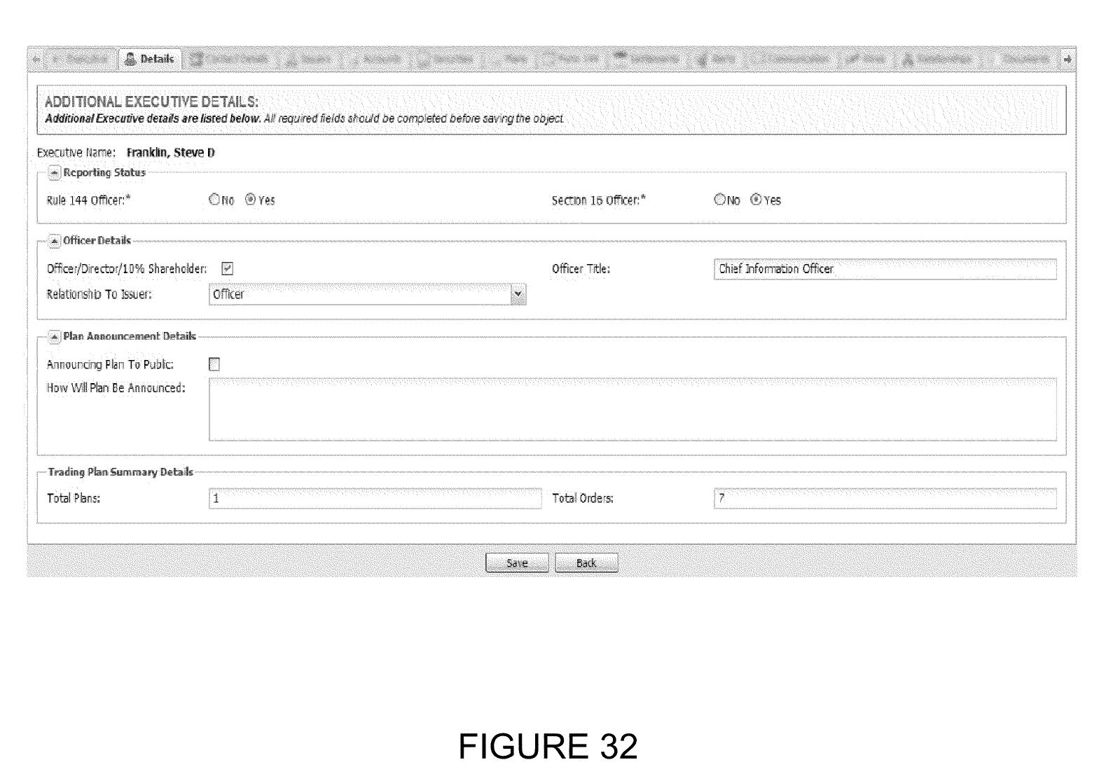

FIG. 32 shows Additional Executive Details, which enables the entry of reporting status, platform and executive relationships, and plan details. In one exemplary embodiment, this information includes, but is not limited to, the following: Rule 144 officer classification, Section 16 insider officer classification, flag for indicating whether executive has officer/director/10% shareholder status, description of executive relationship to issuer, title of executive as applicable to issuer, flag to indicate whether executive's trading plan should be announced to the public, a description of how the plan will be announced (if applicable), the total number of active trading plans administered with the platform, and the total number of plan orders.

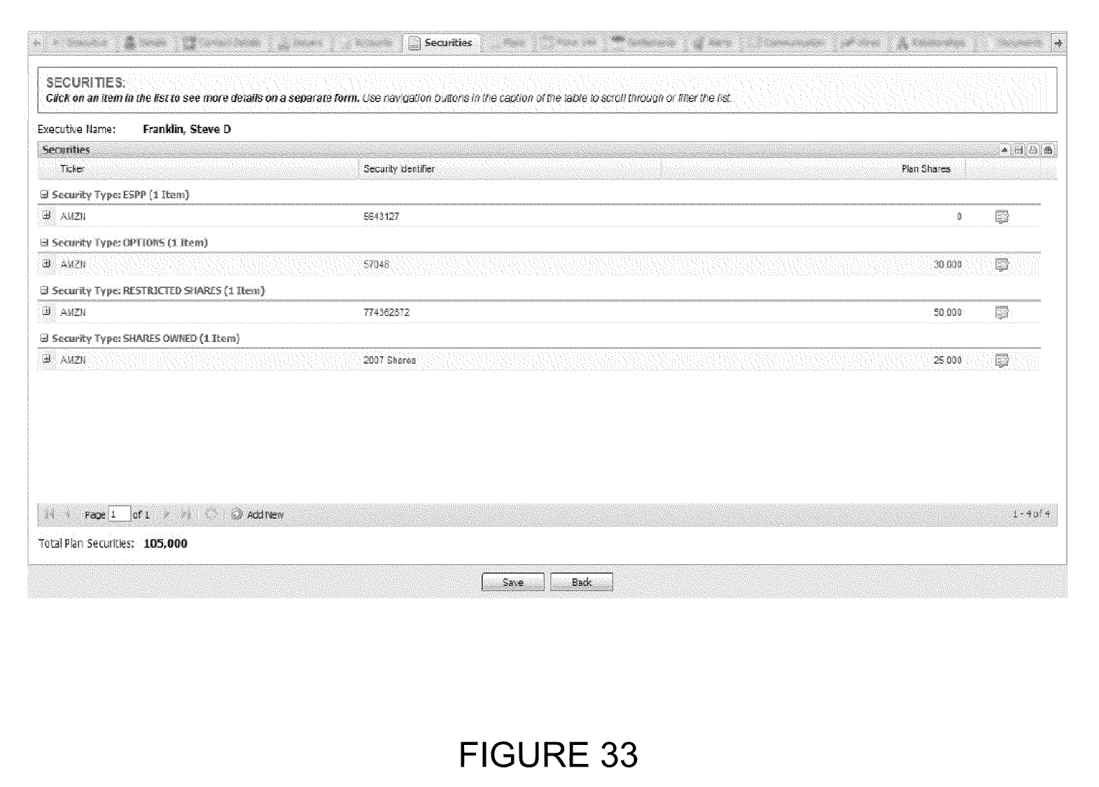

The Securities section displays all securities that are applicable to the executive, as seen in FIG. 33, which may be sorted by a variety of parameters, such as security type. In one exemplary embodiment, this information includes, but is not limited to, the following: ticker symbol of the issuer of the security, the grant number associated with the security, and the total number of plan shares.

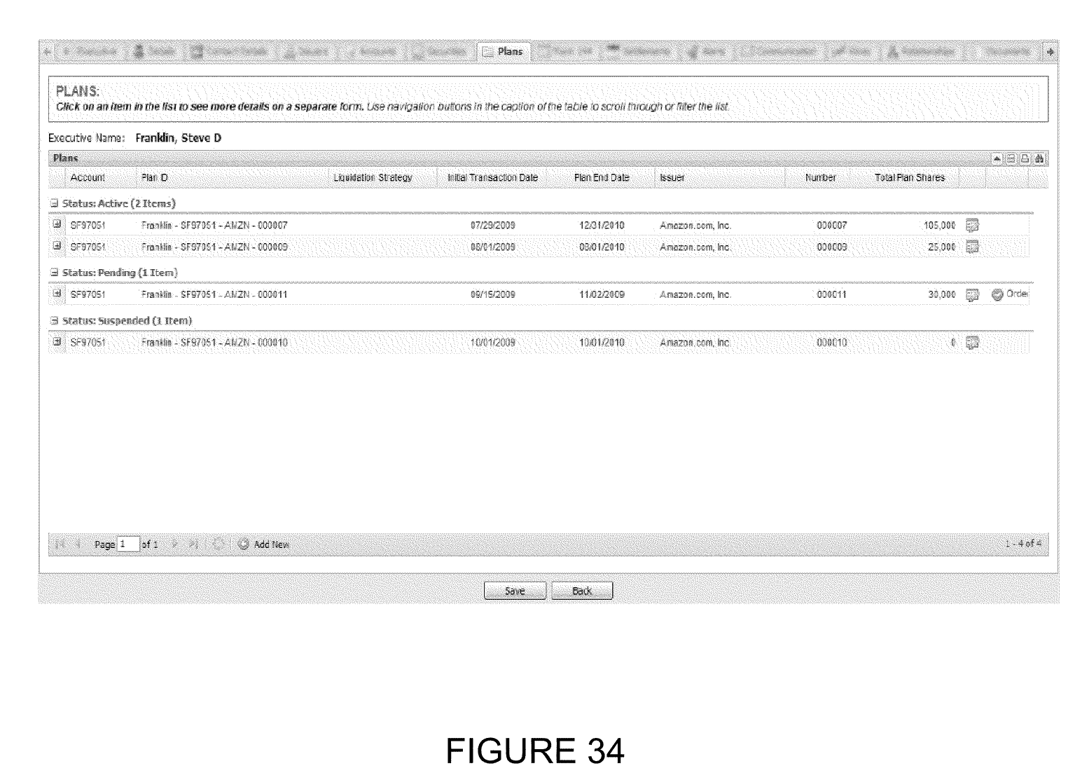

The Plans section outlines any 10b5-1 plans that the executive has elected, as seen in FIG. 34. Information may be sorted by a variety of parameters, such as plan status. In one exemplary embodiment, this information includes, but is not limited to, the following: the account number associated with the firm level account (if different from the plan account), unique identifier for the plan, the selected liquidation strategy for the plan, the first allowable date the plan can trade, the date the plan is no longer in effect, the issuer name, the system-assigned unique identifier for the issuer, and the total shares available to the plan. A button or icon may be used to permit editing plan information, or launching the order creation process.

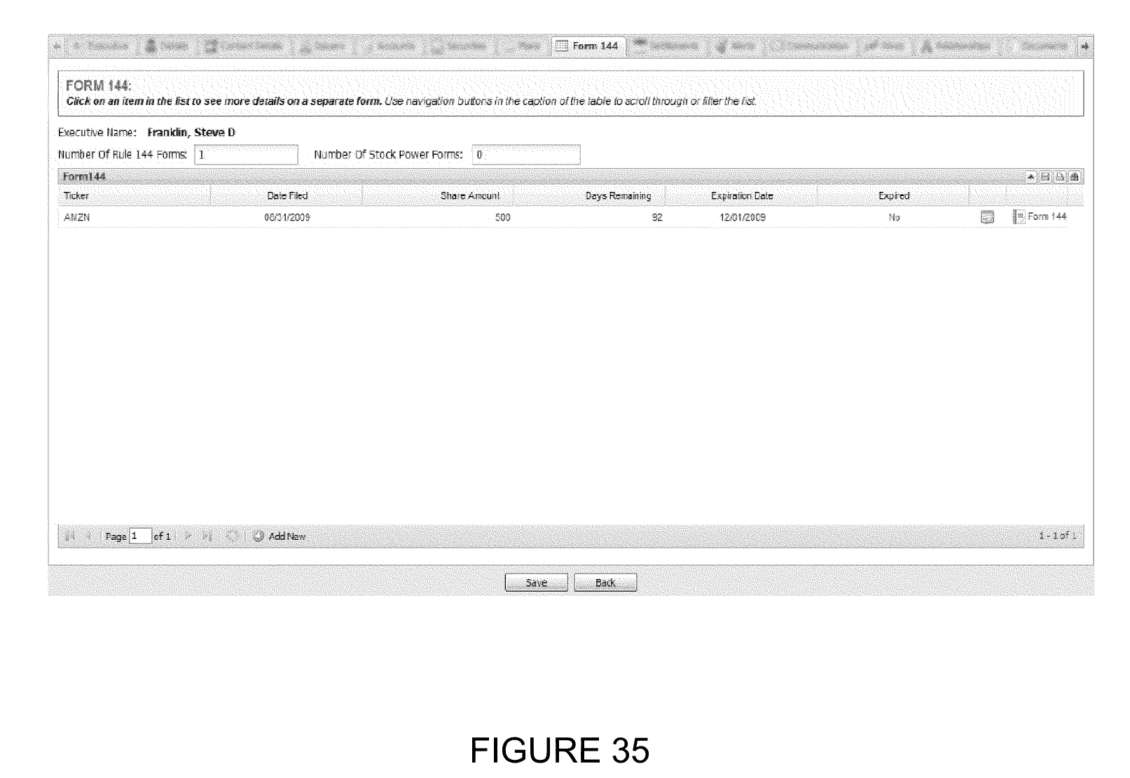

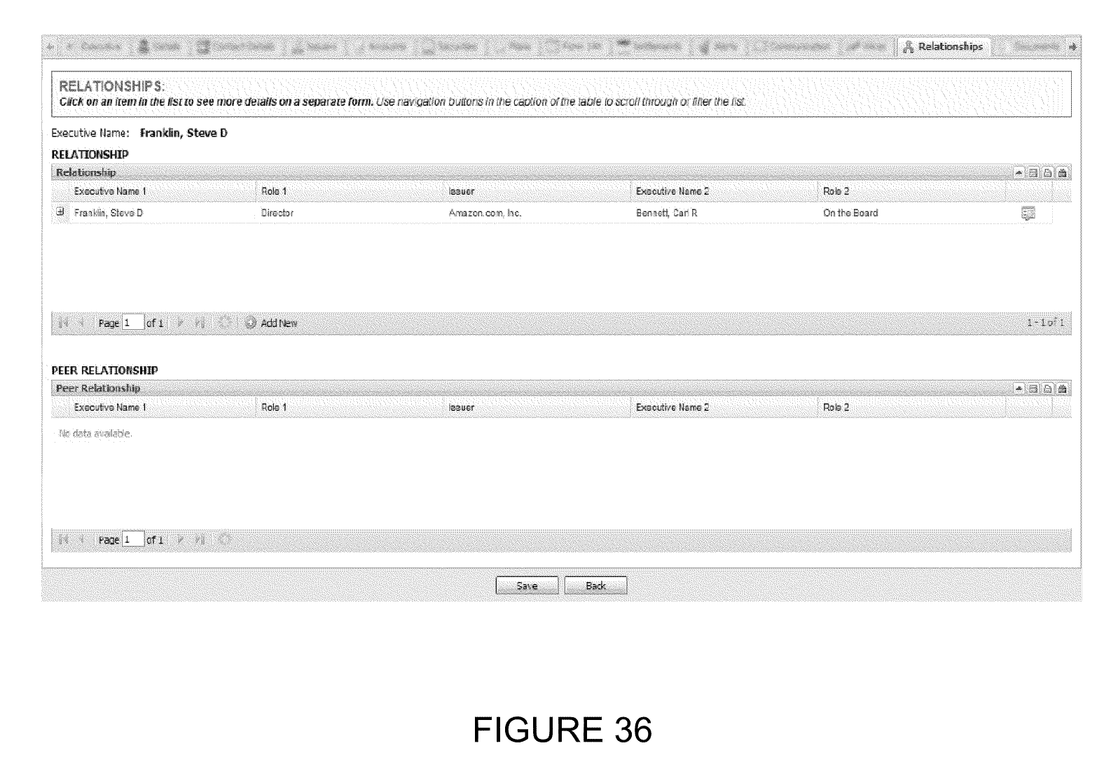

The Form 144 section, as seen in FIG. 35, lists all Form 144 filings that were filed in accordance with the plan. In one exemplary embodiment, this information includes, but is not limited to, the following: issuer ticker symbol, date of filing, number of shares filed for, days remaining for the execution of the indicated filing, the date Form 144 will or has expired, and a flag to indicate if the Form 144 has expired. A button or icon may be used for editing the Form 144 information, or for generating the Form 144 for submission.

The Communication area is used to log and track individual communications with the executive. In one exemplary embodiment, this information includes, but is not limited to, the following: subject of the communication, communication type (e.g., phone, email, etc.), data and time of the communication, and the system users that is assigned to receive and possibly respond to the communication.

The Relationships section provides for the defining of plan-applicable relationships. This section displays the executive's relationships to other entities with trading plans which are attributable to the executive. This information may be presented for peer relationships as well as other relationships in general. In one exemplary embodiment, this information includes, but is not limited to, the following: first executive's name, role of the first executive, issuer referenced in the relationship, the second executive's name, and the role of the second executive.

Executive processes at the executive level provide mechanisms to locate executives, add executives, create a new Form 144, and review plan activity. The Find Executive process launches a query that displays all executives in the platform. Results may be filtered or sorted by a variety of parameters. In one exemplary embodiment, this information includes, but is not limited to, the following: executive name, plan account number, Rule 144 officer classification, Section 16 officer classification, total number of issuers associated with the executive, and the name of the trust associated with the executive.

The Add Executive process launches the new executive entry screen. First, the user selects the firm the executive will be added to, and then fills in the appropriate executive information. Special instructions related to the executive may be included. In one exemplary embodiment, this information includes, but is not limited to, the following: executive name (last name, first name, middle initial, suffix, prefix), name of the trust, account name, gender, date of birth, email address, Rule 144 officer classification, Section 16 officer classification, name of issuer, status of issuer, issuer ticker symbol, executive login name, and password.

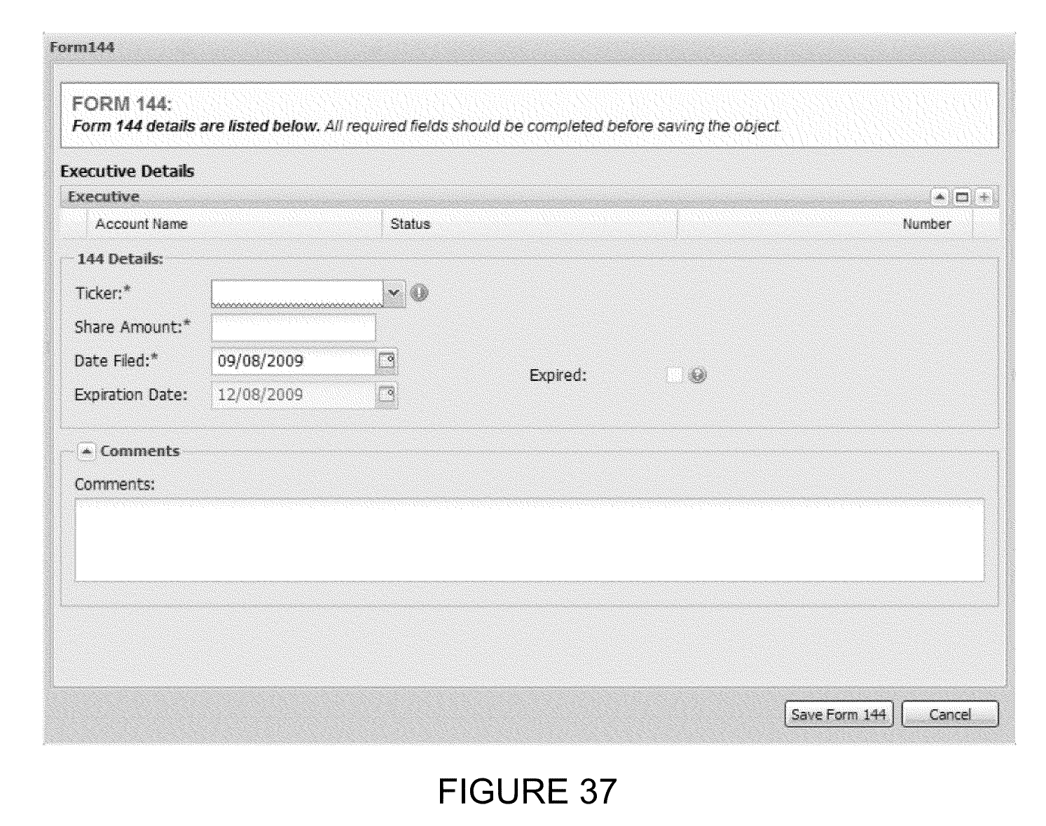

The Create New Form 144 process provides for the creation of a new Form 144 for a selected executive, as seen in FIG. 37. A Form 144 must be filed with the SEC (or other applicable governmental authority) as notice of the proposed sale of restricted securities or securities held by an affiliate of the issuer in reliance on SEC Rule 144 (which is incorporated herein by specific reference for all purposes). The threshold for when a Form 144 must be filed may very. For example, the form may only be required when the amount to be sold during any three-month period exceeds 500 shares or units or has an aggregate sales price in excess of $10,000. The sale must take place within three months of filing the form, and if the securities have not been sold, an amended notice must be filed. In one exemplary embodiment, the information in this process includes, but is not limited to, the following: full name of the executive, executive status, system-assigned unique identifier for executive, issuer ticker symbol, total number of the shares applicable to this Form 144 entry, the date of the Form 144 filing, the date the Form 144 expires, detailed description or comments, and a flag to indicate expiration of the Form 144. The system may electronically file Form 144s with the SEC or other appropriate governmental body.

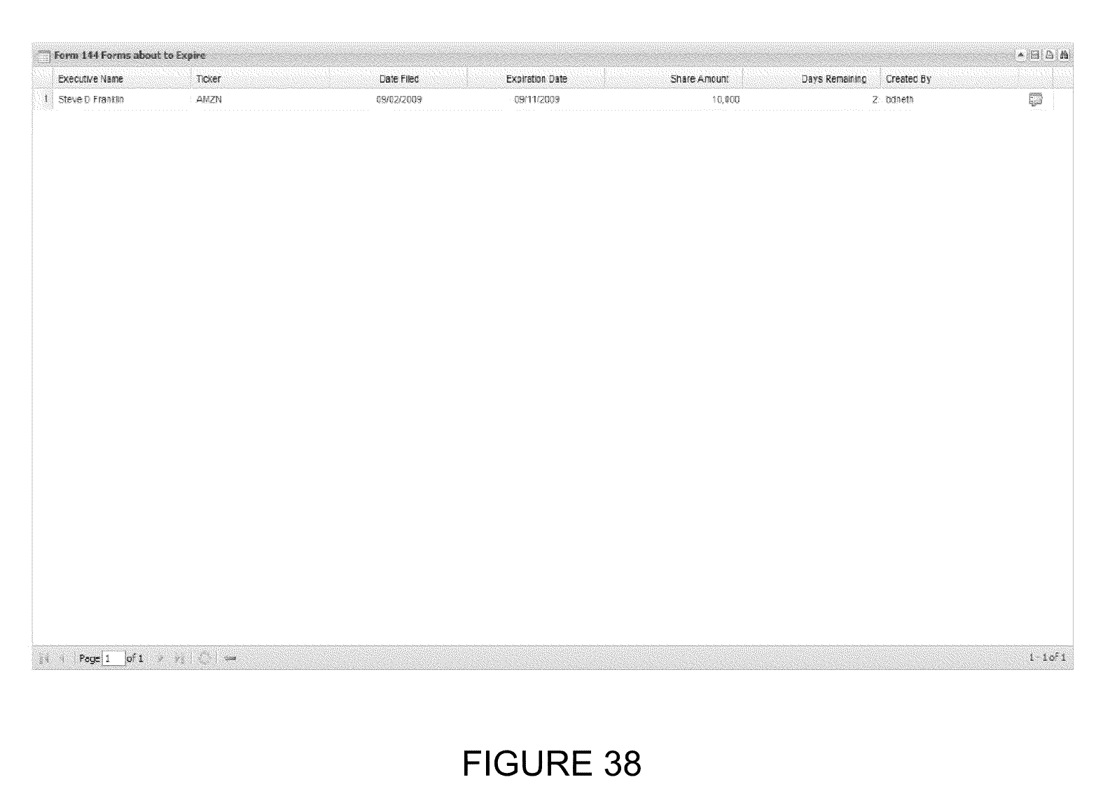

The Form 144 Due to Expire process, as seen in FIG. 38, provides a view of all Form 144 filings due to expire in the next seven days (or other selected period). In one exemplary embodiment, this information includes, but is not limited to, the following: executive name associated with Form 144 entry, issuer ticker symbol, date the Form 144 was filed, expiration date of the Form 144, total number of shares accounted for in the filing, days remaining until expiration, and the user that created the entry.

The Plans process displays a list of all plans entered in the platform, which may be sorted by a variety of parameters, such as plan status. In one exemplary embodiment, this information includes, but is not limited to, the following: executive full name, unique plan identifier, unique account number associated with the plan, issuer ticker symbol, the initial transaction date on the plan, a flag to indicate if the executive is classified as a Rule 144 officer, the status of the plan, the total shares associated with the plan, and the total number of remaining shares if the plan is executed.

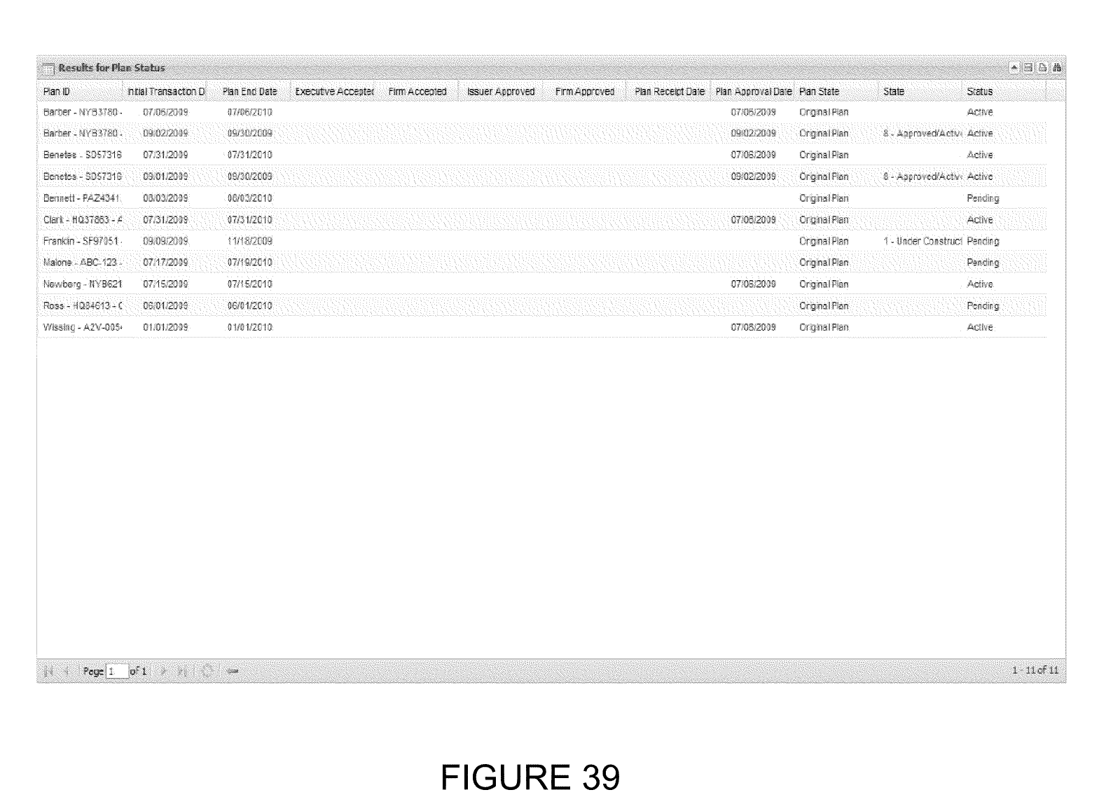

The Plan Status process displays a list of plans sorted by plan identifier, as seen in FIG. 39. In one exemplary embodiment, this information includes, but is not limited to, the following: plan identifier, first allowable date the plan can trade, the date the plan is no longer in effect, the date the executive accepted the plan, the date the firm accepted the plan, the date the issuer approved the plan, the date the firm approved the plan, the date the plan was received, the current state of the plan (e.g., original or amended), the state of the plan (as part of the plan workflow), and the status of the plan.

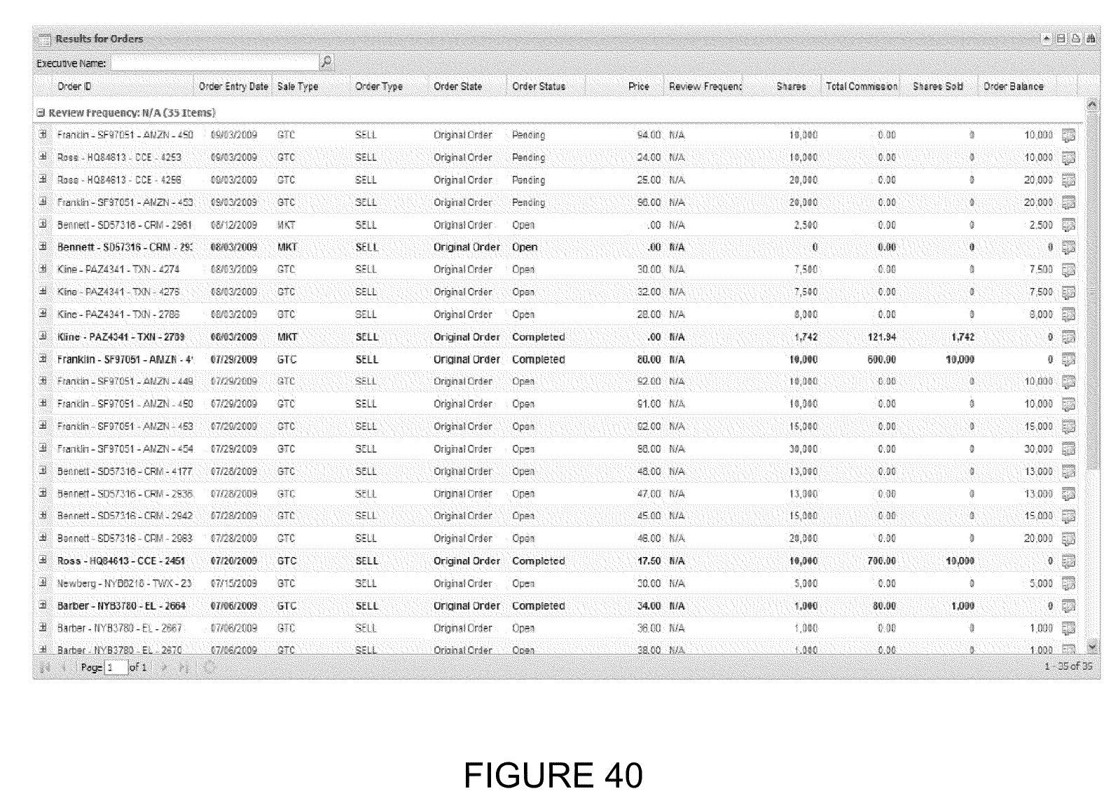

The Orders process displays a list of all orders with the ability to filter the results by a variety of parameters, such as executive name, as seen in FIG. 40. In one exemplary embodiment, this information includes, but is not limited to, the following: system-assigned unique order identifier, the date the order was entered, the type of sale (e.g., MKT, GTC, etc.), order type (e.g., sell or buy), order state (e.g., original or amended), order status (e.g., pending, open, etc.), the price the order is to be executed at, how often or frequently the order is to be reviewed, the total number of shares applicable to this order, the total commission resulting from execution of the order, the total share sold, and the order balance (original share order amount less execution amount).

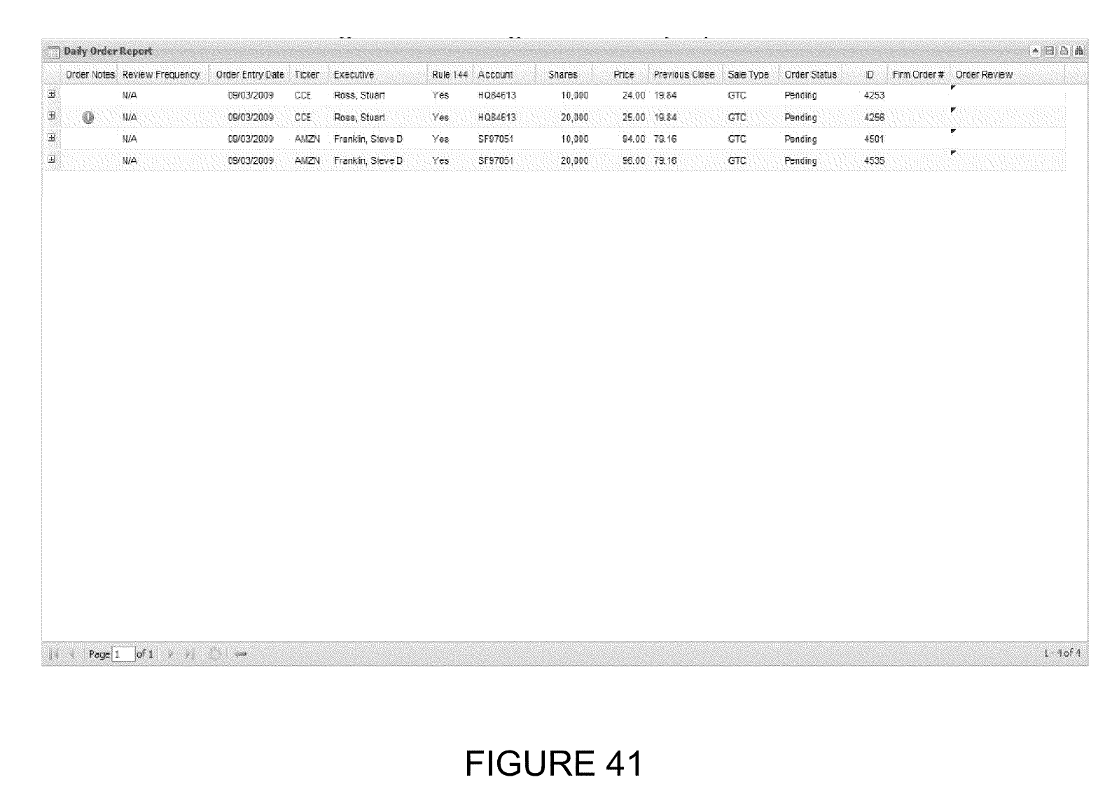

The Daily Order Report Process displays all orders with a given date range, as seen in FIG. 41. The user selects the start and end times or dates, and all orders within the given date range will be displayed. In one exemplary embodiment, this information includes, but is not limited to, the following: flag to indicate if there are notes associated with the order, review frequency, order entry date, issuer ticker symbol, executive name, Rule 144 officer designation flag, account number, number of shares applicable to the order, the price the order was executed against, the closing price of the security on the day prior to the order, the type of sale, the current status of the order, the order identifier, the firm order identifier, and current state of the order with respect to the trader.

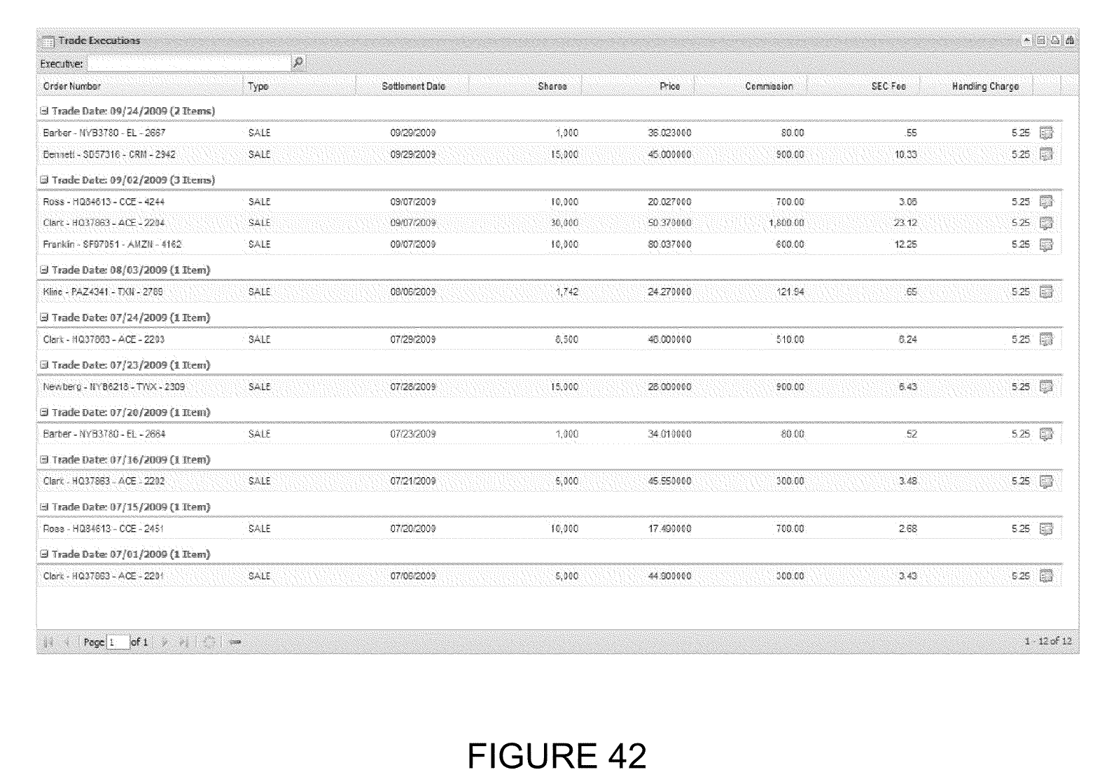

The Executions process, as seen in FIG. 42, displays a list of all executions listed by trade date. In one exemplary embodiment, this information includes, but is not limited to, the following: order number, executive name, account number, issuer ticker symbol, type of transaction (e.g., sell, buy), date of execution settlement, number of shares traded in the execution, price of shares in the execution, commission resulting from the execution, the SEC fee either calculated by the system or received via the execution import, and handling charge (either calculated or imported).

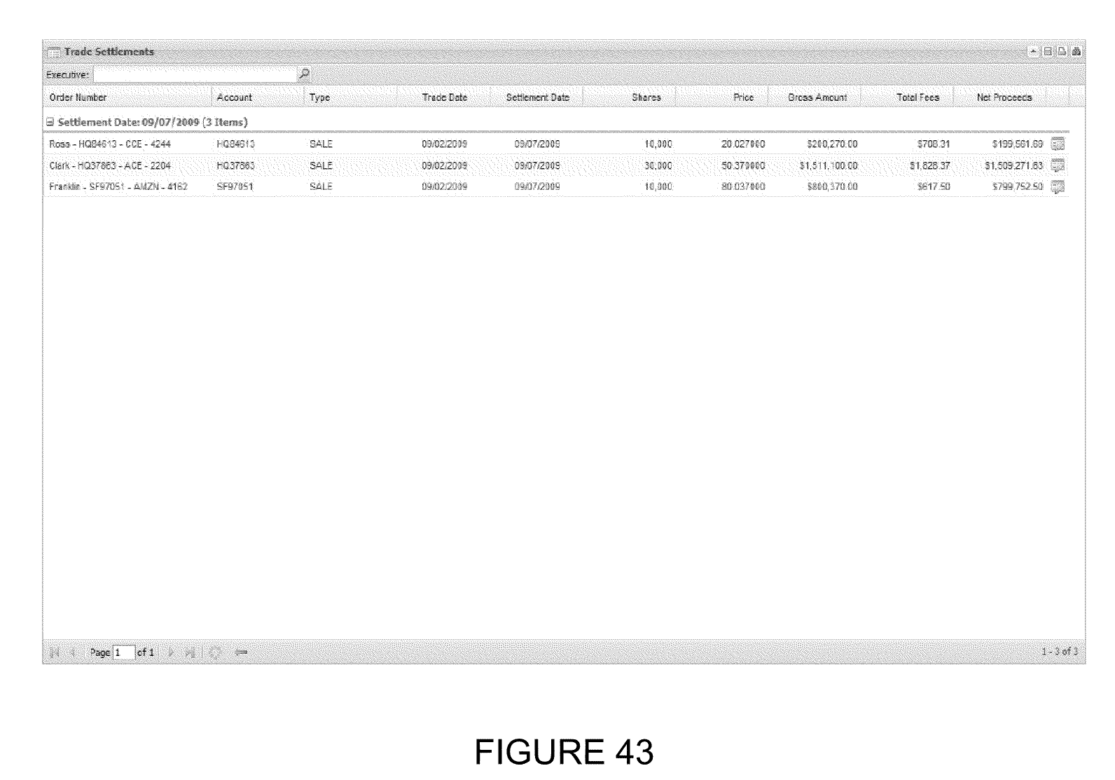

The Trade Settlements process, as seen in FIG. 43, displays all executions for a given date, sorted by various parameters, such as price. The user selects the trade settlement date, and all executions that meet this settlement date parameter are displayed.

In one exemplary embodiment, this information includes, but is not limited to, the following: order number, executive name, account number, issuer ticker symbol, type of transaction (e.g., sell, buy), date the trade was executed, date of execution settlement, number of shares traded in the execution, price of shares in the execution, gross amount of execution (i.e., number of shares time price), the total handling charges and SEC fees either calculated by the system or received via the execution import, and net proceeds (gross amount less total fees).

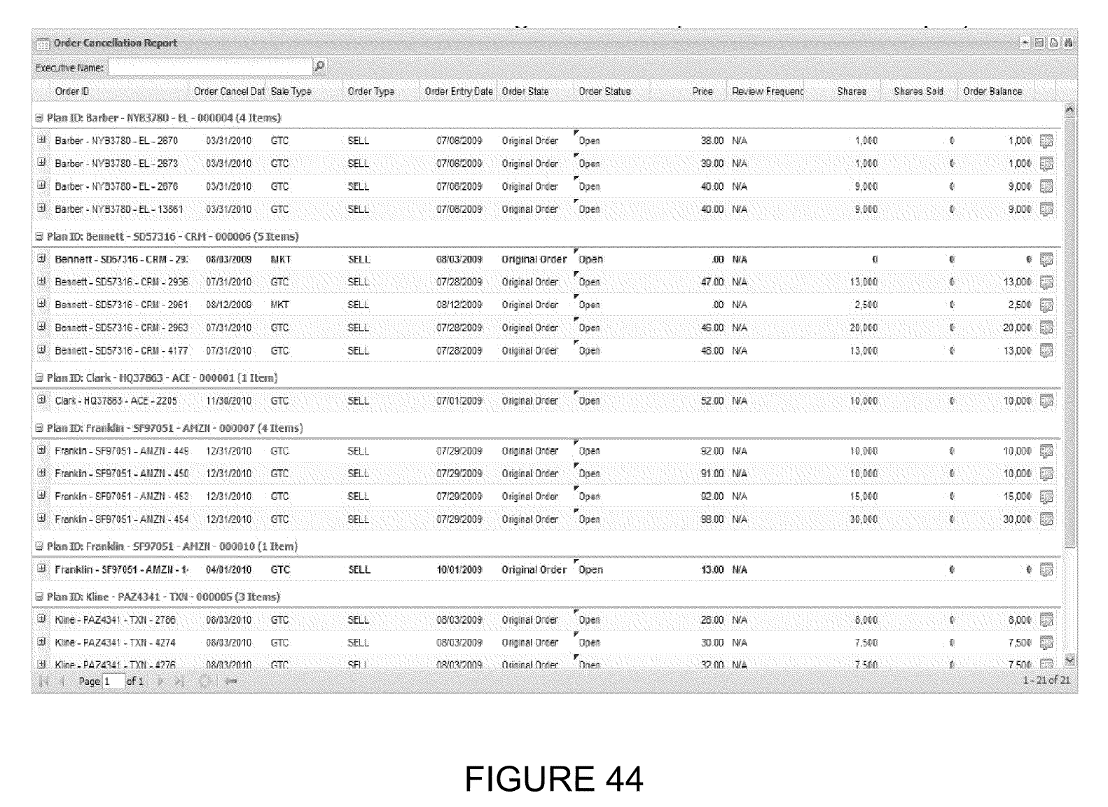

The Orders to Cancel process displays all orders that have the user-selected cancel date, as seen in FIG. 44. In one exemplary embodiment, this information includes, but is not limited to, the following: order number, order cancel date, sale type, order type, order entry date, order state, order status, price the order is to be executed at, total number of shares, shares sold, order balance (remaining shares), and order review frequency (i.e., how often the order is to be reviewed).

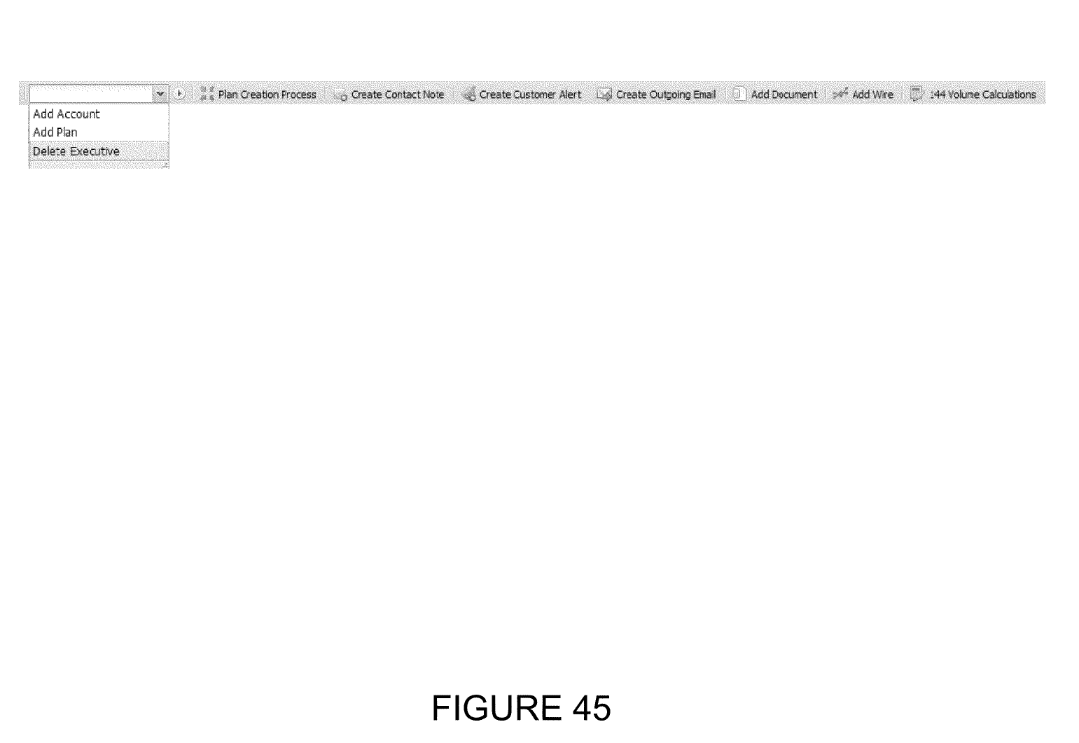

Executive functions are executive level actions that can be performed when a user is working with a selected executive. Each function available at the top of the executive level also is available at specific locations within the executive level. The top function bar, as seen in FIG. 45, serves as a shortcut bar to commonly used actions for a firm. In one embodiment, these functions include, but are not limited to, the following: Add Account; Add Plan; Delete Executive; Plan Creation Process; Create Contact Note; Create Customer Alert; Create Outgoing Email, Add Document; Add Wire, and 144 Volume Calculations.

The Add Account (add account associated to the executive), Add Plan (add plan associated to the executive), Delete Executive (delete currently selected executive), Create Contact Note (create communication level entry associated with executive), Create Customer Alert (create new executive alert entry), Add Document, and Add Wire functions operate similarly to, and use similar data and information as, the corresponding functions at other levels of the system, as discussed above. The other functions are discussed below.

The Create Outgoing Email function acts as short cut to creating an outgoing email to the executive. The sender can add a date the email reply is required by.

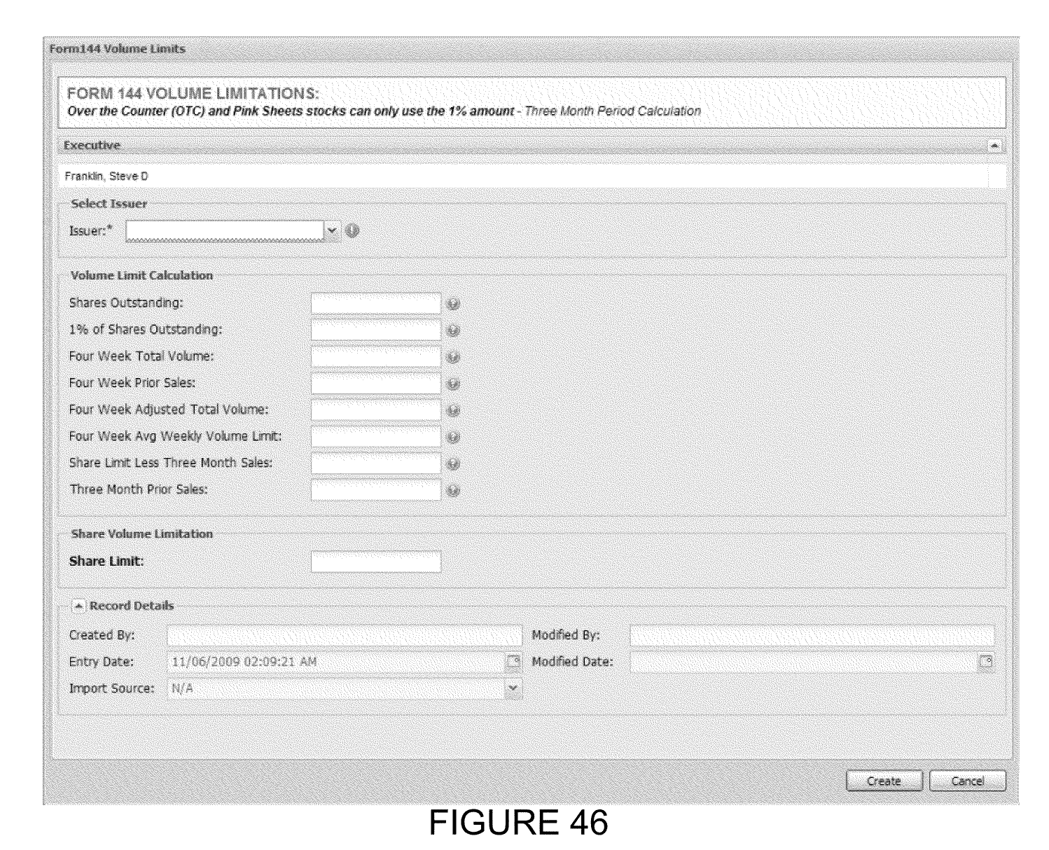

The 144 Volume Calculations function launches the Form 144 Volume Limitations input screen to ensure that Rule 144 limitations are not exceeded, as seen in FIG. 46. In one exemplary embodiment, this information includes, but is not limited to, the following: issuer associated with the Form 144, total shares outstanding, 1% of shares outstanding (calculated by the system), four week total volume (calculated by the system), four week prior sales (calculated by the system), four week adjusted total volume (calculated by the system), four week average weekly volume limit (calculated by the system), share limit less three month sales (calculated by the system), three month prior sales (calculated by the system), share limit (total number of shares that can be sold pursuant to Rule 144 limits), user that created the entry, the date the entry was created, the user that last modified the record, and modification date.

In one exemplary embodiment, the system provides a Calendar section, which permits the user to navigate to a system-level calendar or an individual staff member calendar.

A separate “Common Platform Tasks” section may be provided to enable users to quickly access and use the most-commonly used system features and related process. In one exemplary embodiment, this section includes the following tasks: Create Platform User Account (for an executive); Register Plan Securities; Liquidation Strategies Menu; Choose Liquidation Strategy; Create a Plan; Create 144 Forms; Plan Approval Process; Standard Reports and Queries; and Create an Alert.

The Create Platform User Account process creates an executive account within the system or platform. An executive account may be created by the broker, executive, the 10b5-1 administrative group, or the by stock administration group at an issuer. A form with information is populated to register the executive's name, issuer name, executive's email address, and the broker of record. Other information described above may also be included. A temporary password is automatically emailed to the executive, requiring the executive to establish a new password immediately upon initial login.

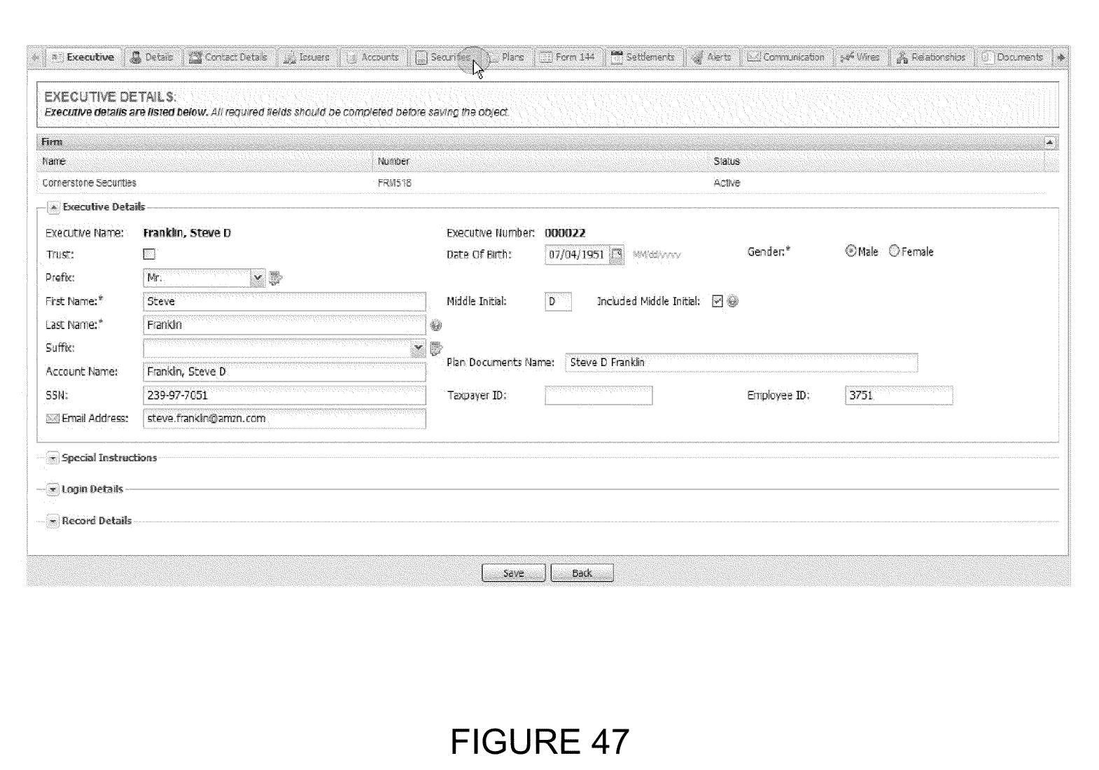

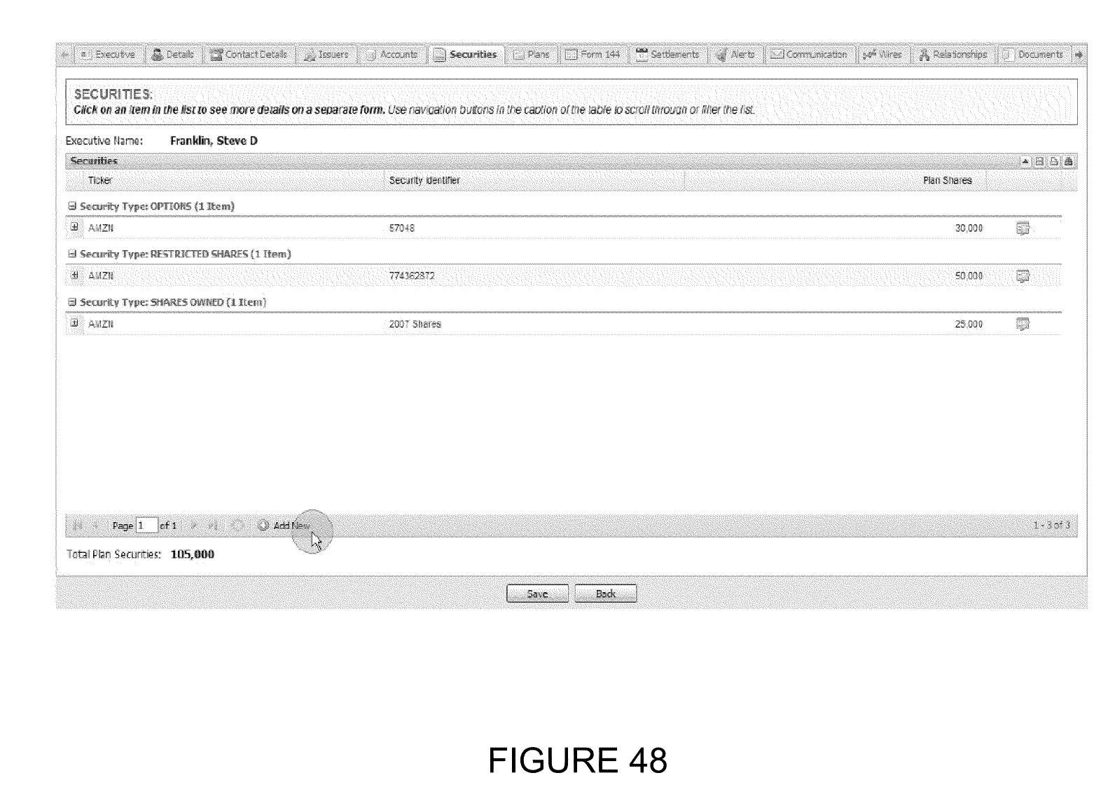

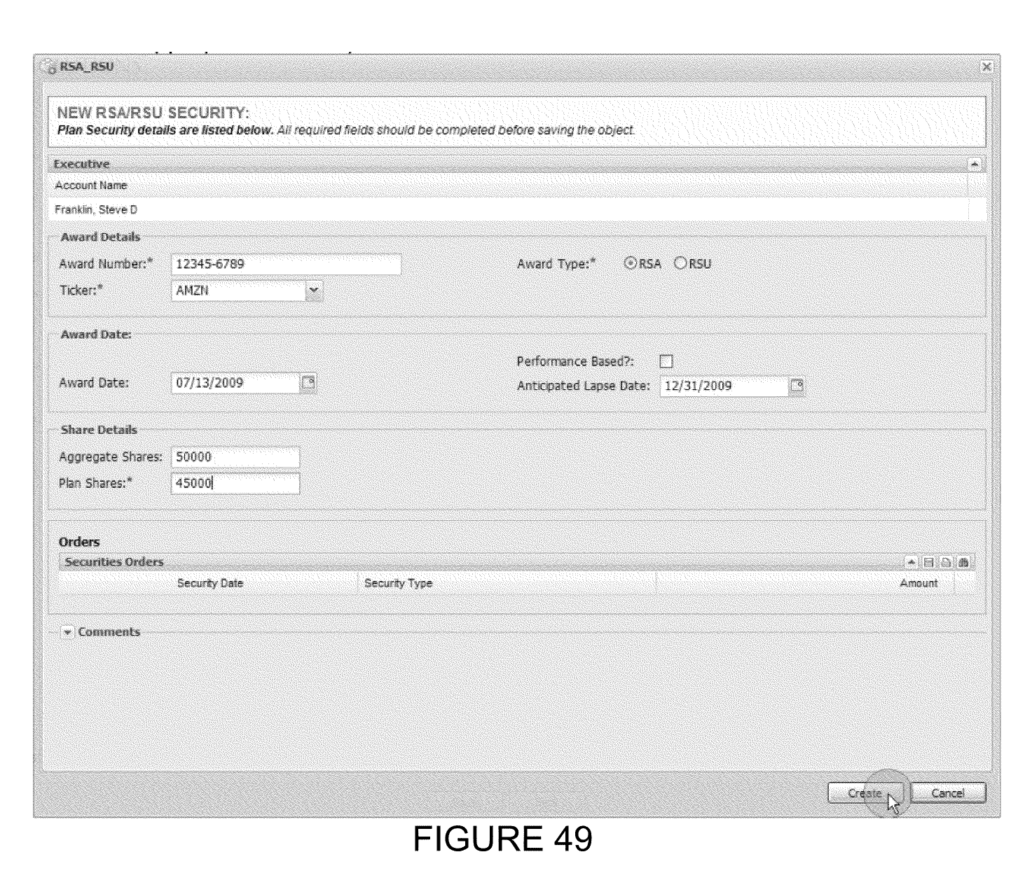

The Register Plan Securities process takes the user through the steps of registering a plan's different securities by type (e.g., Options, RSA/RSU, Shares Owned, Restricted, ESPP). The user selects the securities tab for the executive while at the executive level, as seen in FIG. 47. The user then clicks the “Add New” button at the bottom of the grid, as seen in FIG. 48. The user then selects the securities type to create: Options; RSA/RSU (Restricted Stock Award/Restricted Stock Unit); Shares Owned; Restricted; ESPP (Employee Stock Purchase Plan). The user then fills in the appropriate security information, as seen on FIG. 49, and clicks “Create.”

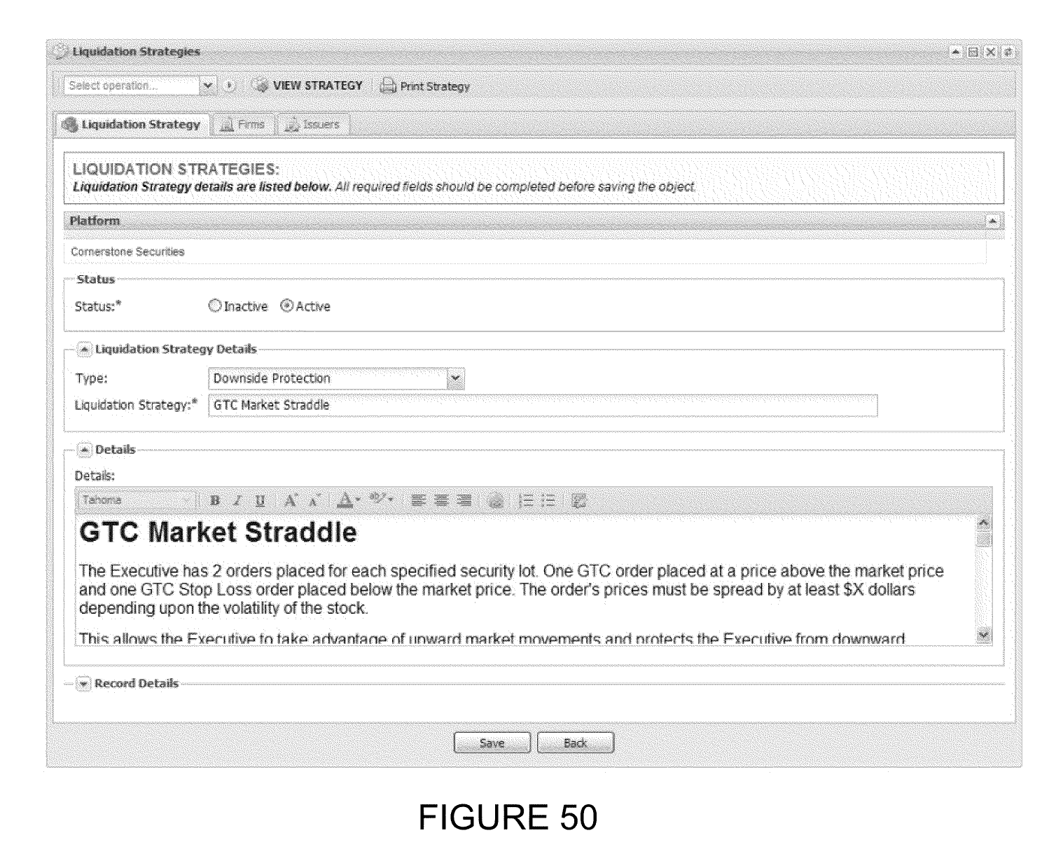

The Liquidation Strategies menu displays all liquidation strategies. By clicking on a strategy name, a page for that strategy is displayed, with the order structure and a text description of the strategy. This menu is available at all levels of the system. At the platform/system and firm levels, there also may be displayed a firm and issuer tab for each strategy which lists the firm and issuer relationships with each respective liquidation strategy. A view of a detailed strategy is shown in FIG. 50.

The Choose Liquidation Strategy option enables the user to review the different strategies to determine which strategy to choose. The user should make the determination if they wish to use one of the liquidation strategies, or employ their own, prior to creation of an order.

The Create a Plan option informs the user how to take the liquidation strategy that they have selected and create their plan's orders. When plan data is initially capture, the plan state remains in the “plan under construction” category until the executive accepts the plan's data and the order structure. The plan creation process tab outlines the steps that need to be completed before the executive accepts the plan. Once the plan is accepted, the plan's data is locked. The executive can then print their plan and any plan-related forms or documents.

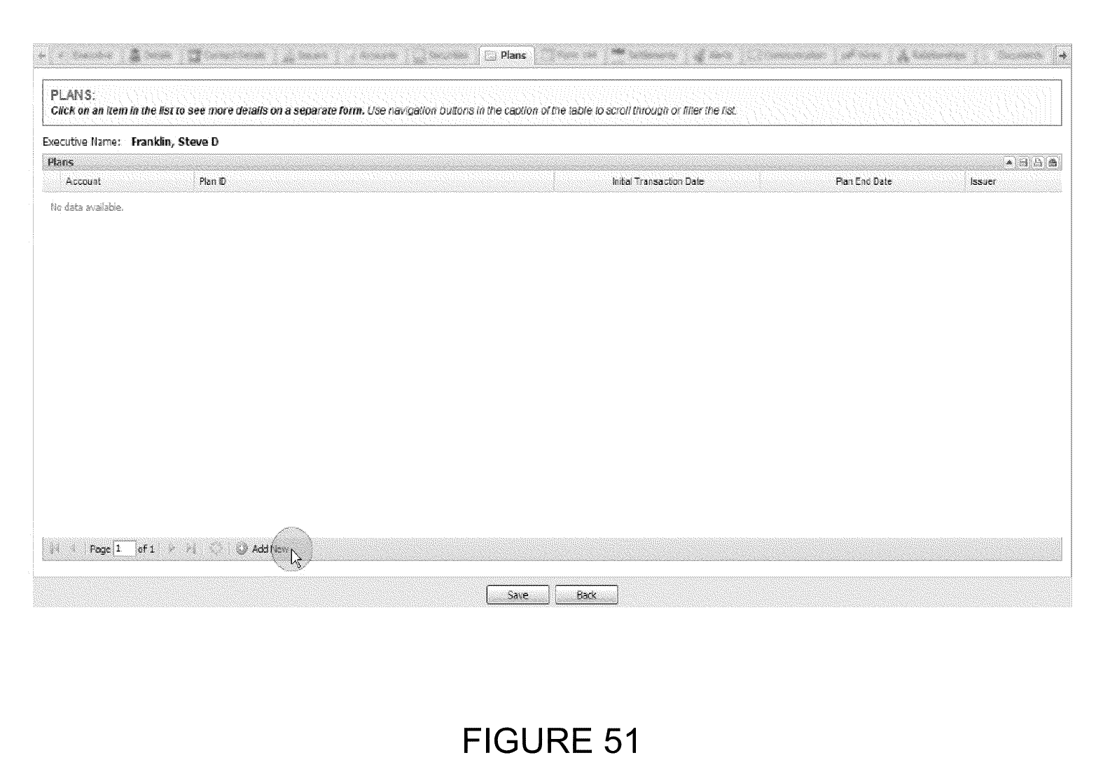

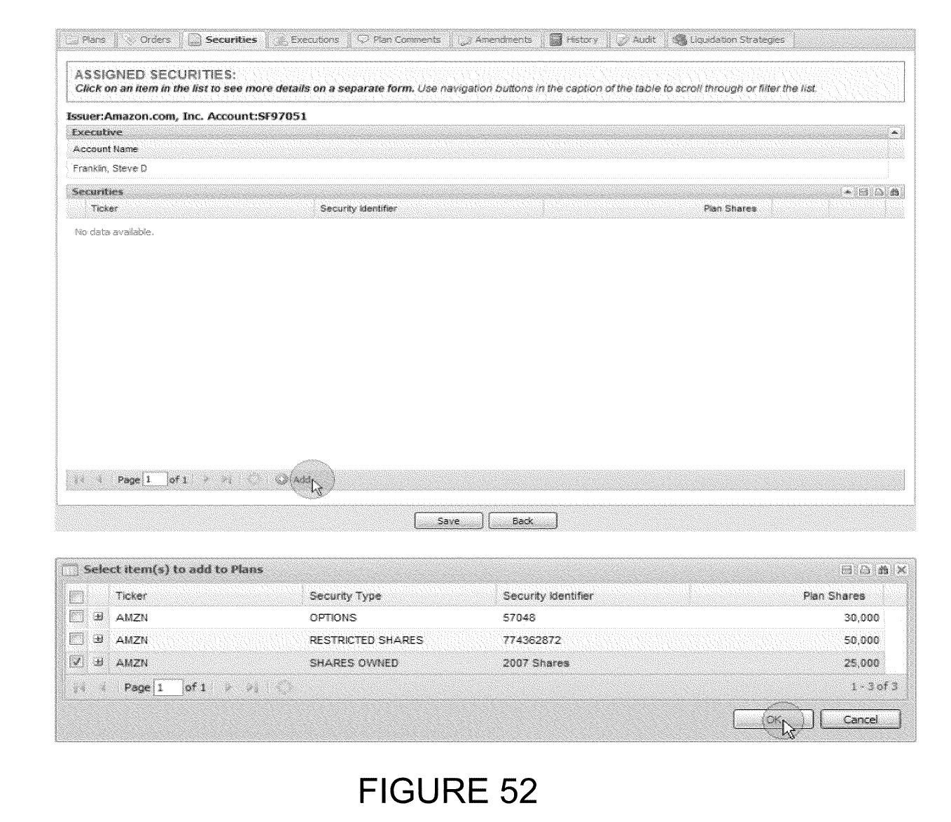

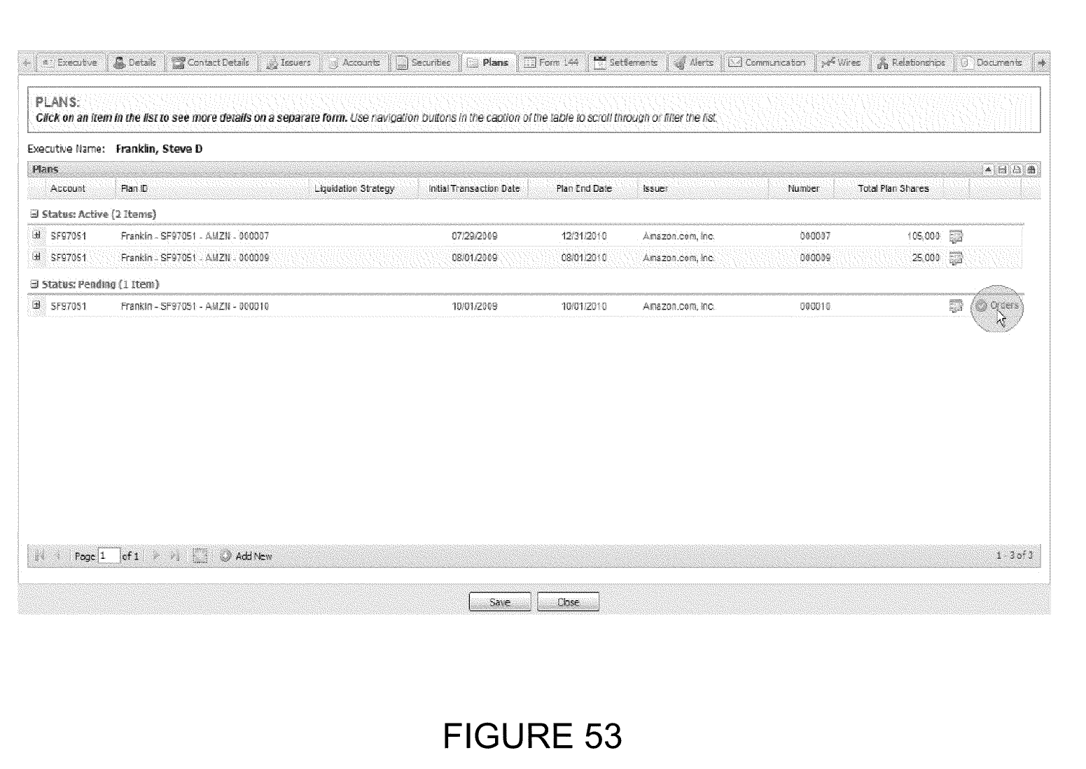

The user creates the parameters of the new plan on the Plans tab by clicking the “Add New” button, as seen in FIG. 51. The user then registers the plan securities on the securities tab (as described above for the Register Plan Securities process). The user clicks on the Plans tab and selects the pending plan, then clicks the securities tab and selects the applicable securities to be assigned to the pending plan from the list, and clicks “OK” (or similar icon) when done, as seen in FIG. 52. The user then clicks on the “Orders” button in the Plans tab to launch the Order Creation Grid, where the user then selects the desired liquidation strategy or strategies, as seen in FIG. 53. The user may scroll through the Liquidation Strategies Menu to review the strategies.

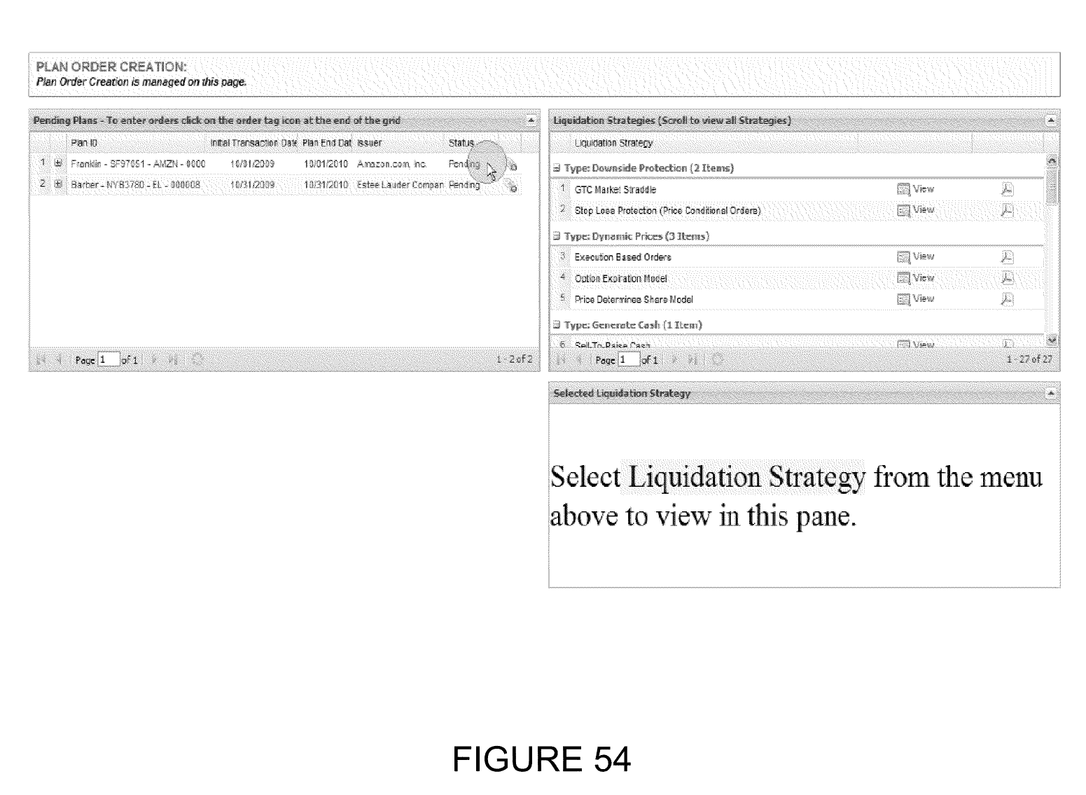

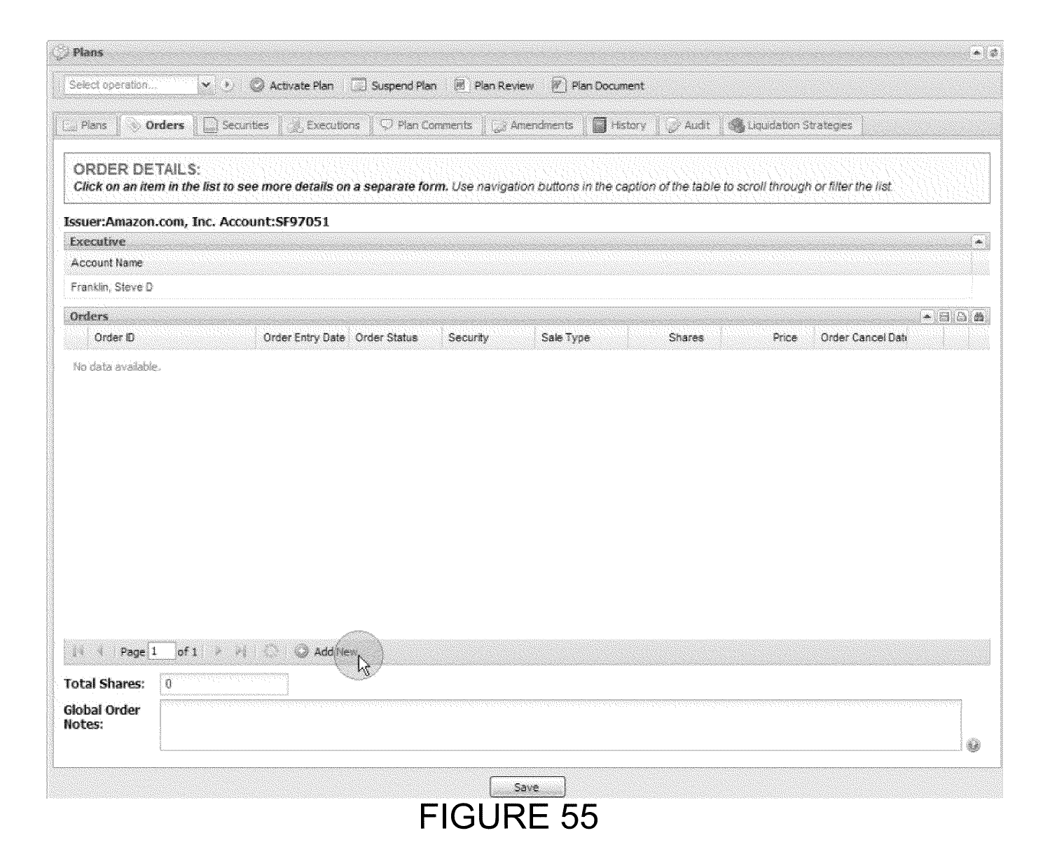

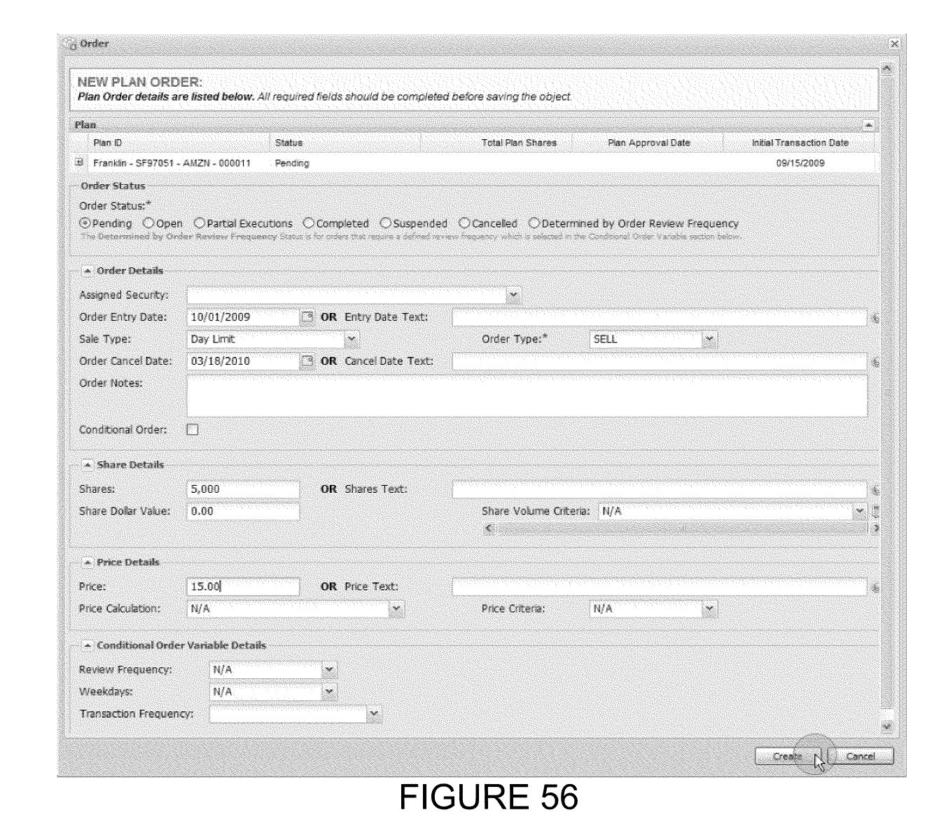

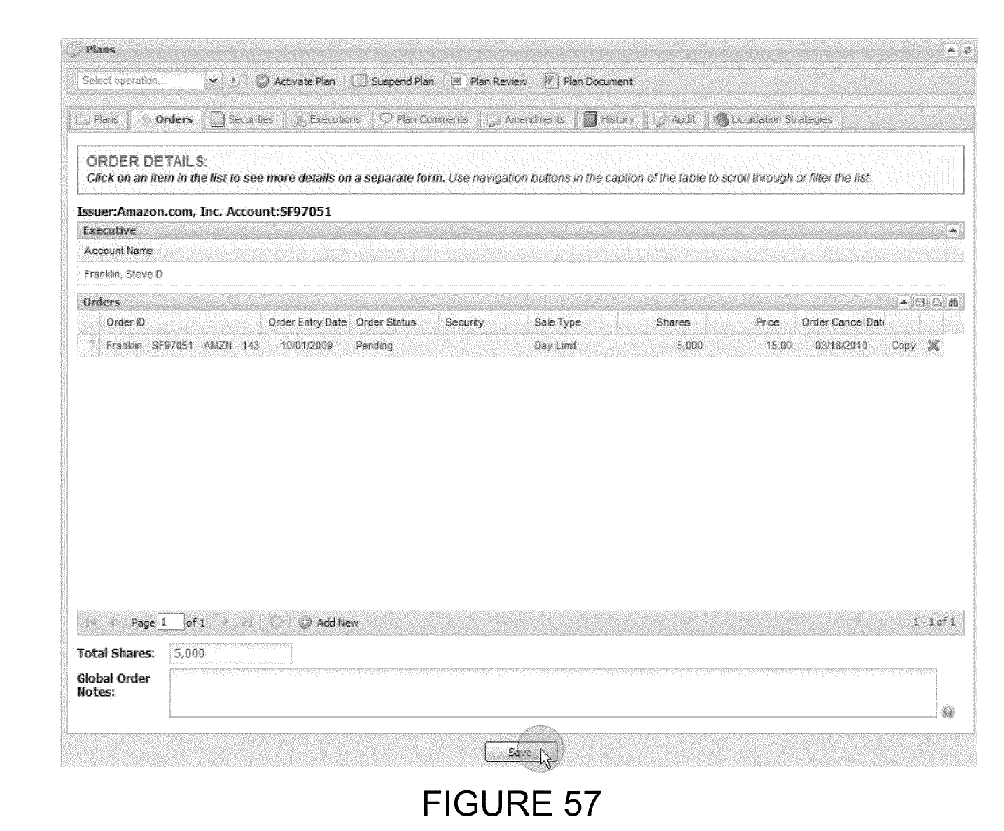

To create the orders for the pending plan, the user clicks on the “Pending Plan” link in the screen, as seen in FIG. 54, which will cause a window to appear with plan details. The user then selects the orders tab (by clicking “Add New” as seen in FIG. 55) to create the plan orders and launch the order entry form. The underlying securities must be assigned during the order creation process. After populating the new plan order screen, the user then clicks “Create” (as seen in FIG. 56), and then saves the order from the orders detail screen (as seen in FIG. 57). All subsequent orders can be created by either clicking the copy button on a previously created order and making any necessary edits (e.g., dates, shares, prices, order notes, etc.), or by clicking the “Add New” button and repeating the above process.

Once the desired plan order structured has been completed, the plan is ready to be accepted by the executive. Once the plan is accepted, the data is locked and no further changes can be made. The accepted plan may be printed by clicking on the plan document icon in the top bar of the plan form. The signed plan documents may be scanned and uploaded under the documents tab at the executive level.

The Create 144 Form sections enables the user to create and print Form 144 forms, in the manner described above.

In one exemplary embodiment, the system manages the plan approval process. Plan states are as follows: under construction (i.e., pending executive acceptance); pending firm acceptance; pending issuer approval; pending receipt; pending final approval; and approved/active.

A plan is in the state of “Under Construction” until it is “Accepted” by the executive. A plan is “Accepted” if the plan is “Accepted” by the executive (by indicating acceptance within the system) or on behalf of the executive by the executive's broker or by an authorized agent (officer) of the issuer (e.g., General Counsel, CEO, CFO, HR Staff, Stock Plan Administrative Staff, etc.). Once the Executive accepts; the plan's data is locked and its state is then changed to “Pending Firm Acceptance.”

This action sends a workflow request to the firm to “Accept” the plan. If the plan is “Rejected” by the firm, the plan's state returns to “Under Construction” and a workflow request (or notification) is sent to the Executive and the Broker notifying them that the plan has been “Rejected”. The Executive (or any authorized user) can adjust the plan to satisfy the firm's request and the plan may be “Accepted” by the executive again to prompt the firm to review and “Accept” the plan.

Once accepted by the firm, the plan's state is changed to “Pending Issuer Approval.” This action sends a workflow request to the issuer to “Approve” the plan. If the plan is “Rejected” by the issuer, then the plan's state returns to “Under Construction.” The executive or authorized user, as above, modifies the plan, and submits it for acceptance again by the firm and the issuer, in order.

Once the plan is “Approved” by the Issuer; a workflow request (or notification) is sent to the broker and the firm notifying them that the plan has been “Approved”. The plan's state is “Pending Receipt” until the firm receives all the executed plan related documents. Once the necessary documents have been received, the plan state is changed to “Pending Final Approval.” This indicates that the plan is ready for the firm's management to approve and activate the plan. Once approved, the plan becomes active and the plans orders are now eligible to be accessed and placed.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A machine for managing securities trading plans, comprising:
a computer with a microprocessor coupled to a memory, said computer in communication with an electronic network, wherein the computer is programmed to:
create a trading plan for an executive in response to input from the executive or authorized agent of the executive;
implement a brokerage firm approval process;
implement a securities issuer approval process;
lock the trading plan from any further changes once the approval processes has been completed; and
provide access to plan orders for trading of securities.

2. The machine of claim 1, wherein the creation of the trading plan comprises the steps of:
providing one or more investment or liquidation strategies to the executive or authorized agent;
receiving instructions from the executive or authorized agent for one or more securities trading orders in accordance with one or more selected investment or liquidation strategies;
forming the plan based on the securities trading orders; and
prompting the executive or authorized agent to accept the plan.

3. The machine of claim 1, wherein the computer is further programmed to create Form 144 forms as required for the securities trades to be carried out by the plan.

4. The machine of claim 3, wherein the computer is further programmed to electronically file the Form 144 files.

5. The machine of claim 1, wherein the computer is further programmed to provide alerts to a broker regarding plan orders for the trading of securities.

6. The machine of claim 1, wherein the computer is further programmed to provide date limitations beyond which some securities cannot be traded.

7. A method for managing securities trading plans, comprising:
creating, on a computer with a microprocessor coupled to a memory, said computer in communication with an electronic network, a trading plan for an executive in response to input from the executive or authorized agent of the executive;
implementing a brokerage firm approval process;
implementing a securities issuer approval process;
locking the trading plan from any further changes once the approval processes has been completed; and
providing access to plan orders for trading of securities.

8. The method of claim 7, wherein the step of creating the trading plan comprises the steps of:
providing one or more liquidation strategies to the executive or authorized agent;
receiving instructions from the executive or authorized agent for one or more securities trading orders in accordance with one or more selected liquidation strategies;
forming the plan based on the securities trading orders; and
prompting the executive or authorized agent to accept the plan.

9. The method of claim 7, further comprising the step of providing alerts to a broker regarding plan orders for the trading of securities.

10. A non-transitory computer-readable storage medium with an executable program stored thereon, wherein the program instructs a microprocessor to perform the following steps:
creating a trading plan for an executive in response to input from the executive or authorized agent of the executive;
implementing a brokerage firm approval process;
implementing a securities issuer approval process;
locking the trading plan from any further changes once the approval processes has been completed; and
providing access to plan orders for trading of securities.

11. The storage medium of claim 10, wherein the step of creating the trading plan comprises the steps of:
providing one or more liquidation strategies to the executive or authorized agent;
receiving instructions from the executive or authorized agent for one or more securities trading orders in accordance with one or more selected liquidation strategies;
forming the plan based on the securities trading orders; and
prompting the executive or authorized agent to accept the plan.

12. The storage medium of claim 10, further wherein the microprocessor provides alerts to a broker regarding plan orders for the trading of securities.
